(19) United States
(12) Patent Application Publication
(10) Pub. No.: US 2022/0114824 A1
(43) Pub. Date: Apr. 14, 2022

(54) COMPUTER-READABLE RECORDING MEDIUM STORING SPECIFYING PROGRAM, SPECIFYING METHOD, AND SPECIFYING DEVICE

(71) Applicant: FUJITSU LIMITED, Kawasaki-shi (JP)

(72) Inventor: Yu Tomita, Fujisawa (JP)

(73) Assignee: FUJITSU LIMITED, Kawasaki-shi (JP)

(21) Appl. No.: 17/558,693

(22) Filed: Dec. 22, 2021

Related U.S. Application Data
(63) Continuation of application No. PCT/JP2019/028021, filed on Jul. 17, 2019.

(51) Int. Cl. G06V 30/19; G06V 30/18; G06V 30/262; G06F 40/30; G06F 40/279

(52) U.S. Cl. CPC G06V 30/19093; G06V 30/1801; G06F 40/279; G06F 40/30; G06V 30/274

(57) ABSTRACT

A non-transitory computer-readable recording medium storing a specifying program for causing a computer to execute processing including: acquiring a first value that indicates a result of inter-document distance analysis between each of a plurality of sentences stored in a storage unit and an input first sentence; acquiring a second value that indicates a result of latent semantic analysis between each of the sentences and the first sentence; calculating similarity between each of the sentences and the first sentence on the basis of a vector that corresponds to each of the sentences and has magnitude based on the first value acquired for each of the sentences and an orientation based on the second value acquired for each of the sentences; and specifying a second sentence similar to the first sentence among the plurality of sentences on the basis of the calculated similarity between each of the sentences and the first sentence.

### CROSS-REFERENCE TO RELATED APPLICATION

This application is a continuation application of International Application PCT/JP2019/028021 filed on Jul. 17, 2019 and designated the U.S., the entire contents of which are incorporated herein by reference.

### FIELD

The present embodiment discussed herein is related to a specifying program, a specifying method, and a specifying device.

### BACKGROUND

In the past, there has been a technology for searching for a sentence similar to a sentence input by a user from among a plurality of sentences stored in a storage unit. This technology is used for a chatbot or the like that searches for a question sentence similar to a question sentence input by the user from among question sentences associated with answer sentences stored in the storage unit, and outputs an answer sentence associated with the found question sentence, for example.

As prior art, for example, there is a technology for generating semantic description of a document from content of the document and calculating a similarity score on the basis of the similarity between the semantic description of the document and a search term. Furthermore, for example, there is a technology for obtaining similarity between a sample document and a reference document for each weighted topic category, and adding up all the topic categories to obtain the similarity between the sample document and the reference document. Furthermore, for example, there is a technology for arranging an icon representing a theme assigned to each axis outside an intersection of a central circle and the each axis radially extending from the center of the circle, and arranging an icon representing a document at a position on the circle, the position being determined according to relevance of the document with respect to each theme and attractive force having the each theme.

Examples of the related art include as follows: Japanese Laid-open Patent Publication No. 2016-076208; Japanese Laid-open Patent Publication No. 2012-003333; and Japanese Laid-open Patent Publication No. 2003-233626.

### SUMMARY

According to an aspect of the embodiments, there is provided a non-transitory computer-readable recording medium storing a specifying program for causing a computer to execute processing. In an example, the processing includes: acquiring a first value that indicates a result of inter-document distance analysis between each of a plurality of sentences stored in a storage unit and an input first sentence; acquiring a second value that indicates a result of latent semantic analysis between each of the sentences and the first sentence; calculating similarity between each of the sentences and the first sentence on the basis of a vector that corresponds to each of the sentences and has magnitude based on the first value acquired for each of the sentences and an orientation based on the second value acquired for each of the sentences; and specifying a second sentence similar to the first sentence among the plurality of sentences on the basis of the calculated similarity between each of the sentences and the first sentence.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a specifying method according to an embodiment;

FIG. 2 is an explanatory diagram illustrating an example of an FAQ system 200;

FIG. 3 is a block diagram illustrating a hardware configuration example of a specifying device 100;

FIG. 4 is an explanatory diagram illustrating an example of content stored in an FAQ list 400;

FIG. 5 is an explanatory diagram illustrating an example of content stored in an LSI score list 500;

FIG. 6 is an explanatory diagram illustrating an example of content stored in a WMD score list 600;

FIG. 7 is an explanatory diagram illustrating an example of content stored in a similarity score list 700;

FIG. 8 is a block diagram illustrating a hardware configuration example of a client device 201;

FIG. 9 is a block diagram illustrating a functional configuration example of the specifying device 100;

FIG. 10 is a block diagram illustrating a specific functional configuration example of the specifying device 100;

FIG. 11 is an explanatory diagram illustrating an example of calculating a similarity score;

FIG. 12 is an explanatory diagram illustrating an example of variations between an LSI score and a WMD score;

FIG. 13 is an explanatory diagram (No. 1) illustrating an effect of the specifying device 100;

FIG. 14 is an explanatory diagram (No. 2) illustrating an effect of the specifying device 100;

FIG. 15 is an explanatory diagram (No. 3) illustrating an effect of the specifying device 100;

FIG. 16 is an explanatory diagram (No. 4) illustrating an effect of the specifying device 100;

FIG. 17 is an explanatory diagram (No. 5) illustrating an effect of the specifying device 100;

FIG. 18 is an explanatory diagram illustrating a display screen example in the client device 201;

FIG. 19 is a flowchart illustrating an example of an overall processing procedure; and

FIG. 20 is a flowchart illustrating an example of a calculation processing procedure.

### DESCRIPTION OF EMBODIMENTS

However, in the prior art, it is difficult to accurately specify the sentence similar to the input sentence from among the plurality of sentences. For example, it is difficult to calculate an index value that accurately indicates how much the input sentence and each sentence of the plurality of sentences are semantically similar, and it is not possible to specify the sentence similar to the input sentence from among the plurality of sentences.

In one aspect, it is an object of the present embodiment to improve the accuracy of specifying a sentence similar to an input sentence from among a plurality of sentences.

Hereinafter, a specifying program, a specifying method, and a specifying device according to the present embodiment will be described with reference to the drawings.

### Example of Specifying Method According to Embodiment

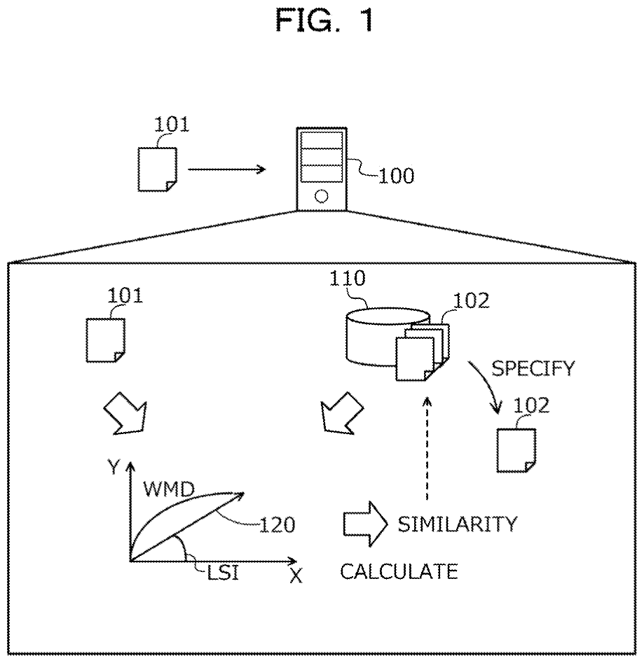

FIG. 1 is an explanatory diagram illustrating an example of a specifying method according to an embodiment. In FIG. 1, a specifying device 100 is a computer for easily specifying a second sentence 102, which is semantically similar to an input first sentence 101, from among a plurality of sentences 102.

In recent years, with the spread of artificial intelligence (AI), a method of accurately specifying a sentence similar to some sentence input by a user from among a plurality of sentences is desired in the field of natural language processing. For example, in a FAQ chatbot, a method of accurately specifying a question sentence semantically similar to a question sentence input by the user from among question sentences associated with answer sentences stored in a storage unit is desired.

However, in the past, it has been difficult to accurately specify the sentence similar to the sentence input by the user from among the plurality of sentences. For example, it has been difficult to calculate similarity that accurately indicates how much the input sentence and each sentence of the plurality of sentences are semantically similar, and it has not been possible to specify the sentence semantically similar to the input sentence from among the plurality of sentences.

In particular, in a Japanese environment, it is difficult to calculate the similarity that accurately indicates how much the input sentence and each sentence of the plurality of sentences are semantically similar due to, for example, the large number of vocabularies and ambiguous sentence expressions. As a result, the probability of succeeding in specifying the sentence semantically similar to the input sentence from among the plurality of sentences may be 70%, or 80% or less.

Here, as the similarity between sentences, a method of calculating Cos similarity between sentences is conceivable. However, since words included in each sentence are expressed by tf-idf or the like, it is difficult to accuracy show how much the sentences are semantically similar. For example, it is not possible to consider how much the words contained in the respective sentences are semantically similar. Furthermore, there are some cases where the Cos similarity becomes large even for semantically different sentences depending on training data.

Furthermore, as the similarity between sentences, a method of calculating the similarity using a neural network by Doc2Vec is conceivable. Since this method uses an initial vector containing random numbers, the similarity is unstable, and it is difficult to accurately show how much relatively short sentences are semantically similar. Furthermore, there is a relatively large number of types of learning parameters, which incurs an increase in cost and workload for optimizing the learning parameters. Furthermore, the accuracy of calculating the similarity is not able to be improved unless the number of training data is increased, which incurs an increase in cost and workload. Furthermore, if a usage scene is different, new training data will be prepared, which incurs an increase in cost and workload.

Furthermore, a method of calculating the similarity between sentences by inter-document distance analysis (word mover's distance) between sentences is conceivable. With this method, it is difficult to increase the probability of succeeding in specifying the sentence semantically similar to the input sentence from among the plurality of sentences to 80% or more. In the following description, the inter-document distance analysis may be referred to as “WMD”. Regarding the WMD, specifically, reference document 1 below can be referred to, for example.

Reference Document 1: Kusner, Matt, et al., “From word embeddings to document distances”, International Conference on Machine Learning, 2015

Furthermore, a method of calculating the similarity between sentences by latent semantic analysis (latent semantic indexing) between sentences is conceivable. Even with this method, it is difficult to increase the probability of succeeding in specifying the sentence semantically similar to the input sentence from among the plurality of sentences to 80% or more. Furthermore, if a word included in any sentence is an unknown word, it becomes difficult to accurately show how much the sentences are semantically similar. In the following description, the latent semantic analysis may be referred to as “LSI”. Regarding the LSI, specifically, reference document 2 below can be referred to, for example.

Reference Document 2: U.S. Pat. No. 4,839,853

Therefore, desired is a method capable of accuracy calculating the semantic similarity between sentences even if unknown words are included, with a relatively small number of sentences that serve as training data prepared for each usage scene and a relatively small number of learning parameter types.

Therefore, in the present embodiment, a specifying method for enabling accurate calculation of semantic similarity between an input sentence and each sentence of a plurality of sentences, and enables accurately specification of a sentence semantically similar to the input sentence among the plurality of sentences, using the WMD and LSI, will be described.

In the example of FIG. 1, the specifying device 100 has a storage unit 110. The storage unit 110 stores the plurality of sentences 102. The sentence 102 is written in Japanese, for example. The sentence 102 may be written in a language other than Japanese, for example. The sentence 102 is, for example, a sentence.

Furthermore, the specifying device 100 accepts an input of the first sentence 101. The first sentence 101 is written in Japanese, for example. The first sentence 101 may be written in a language other than Japanese, for example. The first sentence 101 is, for example, a sentence. The first sentence 101 may be, for example, a series of words.

(1-1) The specifying device 100 acquires a first value indicating a result of the WMD between each sentence 102 and the input first sentence 101 for each sentence 102 of the plurality of sentences 102 stored in the storage unit 110. The specifying device 100 calculates the first value indicating a result of the WMD between each sentence 102 of the plurality of sentences 102 stored in the storage unit 110 and the input first sentence 101, using, for example, a model by Word2Vec.

(1-2) The specifying device 100 acquires a second value indicating a result of the LSI between each sentence 102 and the first sentence 101 for each sentence 102 of the plurality of sentences 102 stored in the storage unit 110. The specifying device 100 calculates the second value indicating a result of the LSI between each sentence 102 of the plurality of sentences 102 stored in the storage unit 110 and the input first sentence 101, using, for example, a model by the LSI.

(1-3) The specifying device 100 calculates the similarity between each sentence 102 and the first sentence 101 on the basis of a vector 120 corresponding to the sentence 102. The vector 120 corresponding to each sentence 102 has, for example, magnitude based on the first value acquired for the sentence 102 and an orientation based on the second value acquired for the sentence 102.

(1-4) The specifying device 100 specifies the second sentence 102 similar to the first sentence 101 among the plurality of sentences 102 on the basis of the calculated similarity between each sentence 102 and the first sentence 101. The specifying device 100 specifies, for example, the sentence 102 having the maximum calculated similarity among the plurality of sentences 102, as the second sentence 102 similar to the first sentence 101.

Thereby, the specifying device 100 can calculate the similarity accurately indicating how much the input first sentence 101 and each sentence 102 of the plurality of sentences 102 are semantically similar. Then, the specifying device 100 can accurately specify the sentence 102 semantically similar to the input first sentence 101 from among the plurality of sentences 102.

Furthermore, the specifying device 100 can calculate the similarity accurately indicating how much the input first sentence 101 and each sentence 102 of the plurality of sentences 102 are semantically similar even when the number of sentences serving as training data prepared by the user is relatively small. As a result, the specifying device 100 can suppress an increase in cost and workload.

Since the specifying device 100 can generate, for example, a model by Word2Vec on the basis of the Japanese version of Wikipedia, the user can avoid preparing a sentence serving as training data. Furthermore, since the specifying device 100 may generate, for example, the model by Word2Vec on the basis of the plurality of sentences 102 stored in the storage unit 110, the user can avoid preparing a sentence serving as training data other than the sentences 102 stored in the storage unit 110. Then, the specifying device 100 can divert the model by Word2Vec even in a case where the usage scene is different.

Furthermore, since the specifying device 100 can generate, for example, the model by the LSI on the basis of the plurality of sentences 102 stored in the storage unit 110, the user can avoid preparing a sentence serving as training data other than the sentences 102 stored in the storage unit 110.

Furthermore, the specifying device 100 can calculate the similarity accurately indicating how much the input first sentence 101 and each sentence 102 of the plurality of sentences 102 are semantically similar even when the number of types of learning parameters is relatively small. For example, when generating a model by LSI, the specifying device 100 simply adjusts one type of learning parameter indicating the number of dimensions, and can suppress an increase in cost and workload. Furthermore, the specifying device 100 can generate the model by LSI in a relatively short time, and can suppress an increase in cost and workload.

Furthermore, the specifying device 100 can calculate the similarity accurately indicating how much the input first sentence 101 and each sentence 102 of the plurality of sentences 102 are semantically similar even when unknown words are included in the input first sentence 101. Since the specifying device 100 uses, for example, the first value indicating the result of WMD between the input first sentence 101 and each sentence 102 of the plurality of sentences 102, the specifying device 100 can improve the accuracy of calculating the similarity even when unknown words are included in the input first sentence 101.

Then, the specifying device 100 can calculate the similarity accurately indicating how much the input first sentence 101 and each sentence 102 of the plurality of sentences 102 are semantically similar even in the Japanese environment. As a result, the specifying device 100 can improve the probability of succeeding in specifying the sentence 102 semantically similar to the input first sentence 101 from among the plurality of sentences 102.

Here, a case in which the specifying device 100 calculates the first value and the second value has been described but the embodiment is not limited to the case. For example, a device other than the specifying device 100 may calculate the first value and the second value, and the specifying device 100 may receive the first value and the second value.

(Example of FAQ System 200)

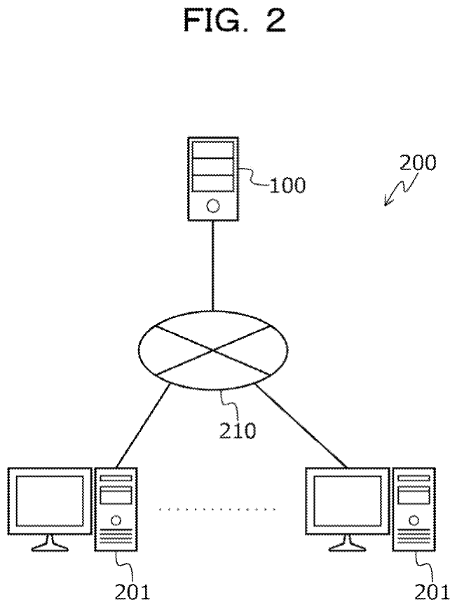

Next, one example of an FAQ system 200 to which the specifying device 100 illustrated in FIG. 1 is applied will be described with reference to FIG. 2.

FIG. 2 is an explanatory diagram illustrating an example of the FAQ system 200. In FIG. 2, the FAQ system 200 includes the specifying device 100 and client devices 201.

In the FAQ system 200, the specifying device 100 and the client devices 201 are connected via a wired or wireless network 210. The network 210 is, for example, a local area network (LAN), a wide area network (WAN), the Internet, or the like.

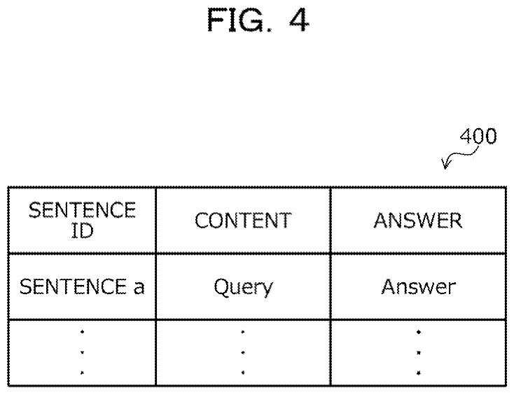

The specifying device 100 is a computer that stores each question sentence of a plurality of question sentences in association with an answer sentence to the question sentence in the storage unit. The question sentence is, for example, a sentence. The specifying device 100 stores, for example, each question sentence of a plurality of question sentences in association with an answer sentence to the question sentence, using an FAQ list 400 to be described below in FIG. 4.

Furthermore, the specifying device 100 accepts an input of a question sentence from the user of the FAQ system 200. The question sentence from the user is, for example, a sentence. The question sentence from the user may be, for example, a series of words. Furthermore, the specifying device 100 specifies a question sentence semantically similar to the input question sentence from among the plurality of question sentences stored in the storage unit. Furthermore, the specifying device 100 outputs an answer sentence associated with the specified question sentence.

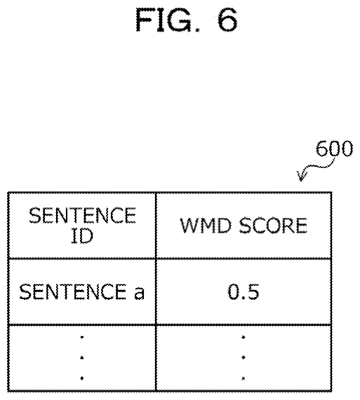

The specifying device 100 receives, for example, the question sentence from the user of the FAQ system 200 from the client device 201. The specifying device 100 calculates, for example, the similarity by the LSI between the input question sentence and each question sentence of the plurality of question sentences stored in the storage unit. In the following description, the similarity by the LSI may be referred to as “LSI score”. Then, the specifying device 100 stores the calculated LSI score, using an LSI score list 500 to be described below in FIG. 6.

Next, the specifying device 100 calculates, for example, the similarity by the WMD between the input question sentence and each question sentence of the plurality of question sentences stored in the storage unit. In the following description, the similarity by the WMD may be referred to as “WMD score”. Then, the specifying device 100 stores the calculated WMD score, using a WMD score list 600 to be described below in FIG. 6.

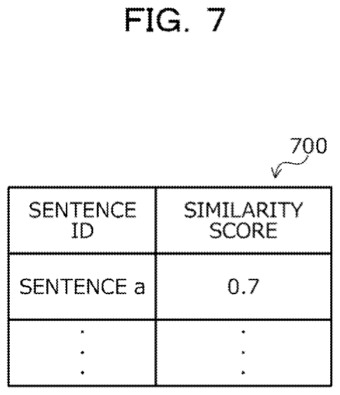

Next, the specifying device 100 calculates a similarity score between the input question sentence and each question sentence of the plurality of question sentences stored in the storage unit on the basis of, for example, the calculated LSI score and WMD score, and stores the similarity score, using a similarity score list 700 to be described below in FIG. 7. Then, the specifying device 100 specifies a question sentence semantically similar to the input question sentence from among the plurality of question sentences stored in the storage unit on the basis of, for example, the calculated similarity score.

The specifying device 100 causes the client device 201 to display, for example, the answer sentence associated with the specified question sentence. Examples of the specifying device 100 include a server, a personal computer (PC), a tablet terminal, a smartphone, a wearable terminal, and the like. A microcomputer, a programmable logic controller (PLC), or the like may be adopted.

The client device 201 is a computer used by the user of the FAQ system 200. The client device 201 transmits the question sentence to the specifying device 100 on the basis of an operation input of the user of the FAQ system 200. The client device 201 displays the answer sentence associated with the question sentence semantically similar to the transmitted question sentence under the control of the specifying device 100. Examples of the client device 201 include a PC, a tablet terminal, a smartphone, and the like.

Here, a case in which the specifying device 100 and the client device 201 are different devices has been described. However, the embodiment is not limited to the case. For example, the specifying device 100 may be a device that also operates as the client device 201. Furthermore, in this case, the FAQ system 200 may not include the client device 201.

As a result, the FAQ system 200 can implement a service for providing an FAQ to the user of the FAQ system 200. In the following description, the operation of the specifying device 100 will be described by taking the above-described FAQ system 200 as an example.

(Hardware Configuration Example of Specifying Device 100)

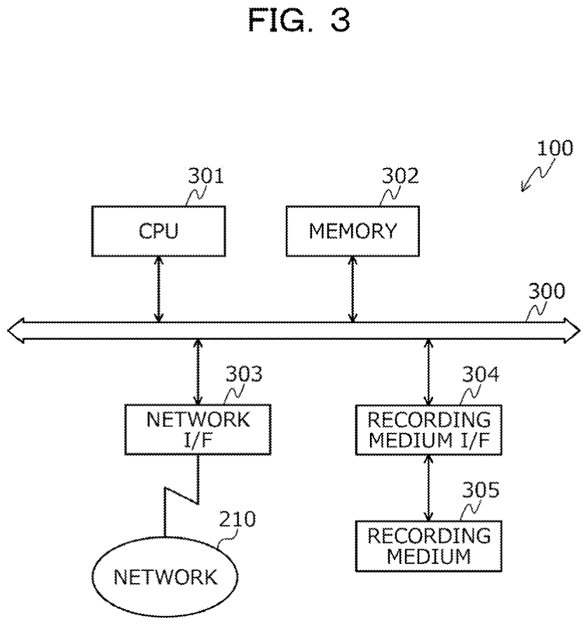

Next, a hardware configuration example of the specifying device 100 will be described with reference to FIG. 3.

FIG. 3 is a block diagram illustrating a hardware configuration example of the specifying device 100. In FIG. 3, the specifying device 100 has a central processing unit (CPU) 301, a memory 302, a network interface (I/F) 303, a recording medium I/F 304, and a recording medium 305. Furthermore, the individual components are connected to each other by a bus 300.

Here, the CPU 301 performs overall control of the specifying device 100. The memory 302 includes, for example, a read only memory (ROM), a random access memory (RAM), a flash ROM, and the like. Specifically, for example, the flash ROM or the ROM stores various programs, and the RAM is used as a work area for the CPU 301. The programs stored in the memory 302 are loaded into the CPU 301 to cause the CPU 301 to execute coded processing.

The network I/F 303 is connected to the network 210 through a communication line and is connected to another computer via the network 210. Then, the network I/F 303 is in charge of an interface between the network 210 and the inside and controls input and output of data to and from another computer. For example, the network I/F 303 is a modem, a LAN adapter, or the like.

The recording medium I/F 304 controls reading and writing of data from and to the recording medium 305 under the control of the CPU 301. For example, the recording medium I/F 304 is a disk drive, a solid state drive (SSD), a universal serial bus (USB) port, or the like. The recording medium 305 is a nonvolatile memory that stores data written under the control of the recording medium I/F 304. For example, the recording medium 305 is a disk, a semiconductor memory, a USB memory, or the like. The recording medium 305 may be attachable to and detachable from the specifying device 100.

The specifying device 100 may further include, for example, a keyboard, a mouse, a display, a printer, a scanner, a microphone, a speaker, or the like in addition to the above-described components. Furthermore, the specifying device 100 may include, for example, a plurality of the recording medium I/Fs 304 and the recording media 305. Furthermore, the specifying device 100 needs not include, for example, the recording medium I/F 304 and the recording medium 305.

(Content Stored in FAQ List 400)

Next, an example of content stored in the FAQ list 400 will be described with reference to FIG. 4. The FAQ list 400 is implemented by, for example, a storage area of the memory 302, the recording medium 305, or the like of the specifying device 100 illustrated in FIG. 3.

FIG. 4 is an explanatory diagram illustrating an example of content stored in the FAQ list 400. As illustrated in FIG. 4, the FAQ list 400 has fields for sentence ID, content, and answer. The FAQ list 400 stores FAQ information as a record by setting information in each field for each sentence. In the field for sentence ID, a sentence ID assigned to a sentence and specifying the sentence is set. In the field for content, a sentence identified by the sentence ID is set. In the field for content, a question sentence identified by the sentence ID is set, for example. In the field for answer, an answer sentence corresponding to the question sentence identified by the sentence ID is set.

(Content Stored in LSI Score List 500)

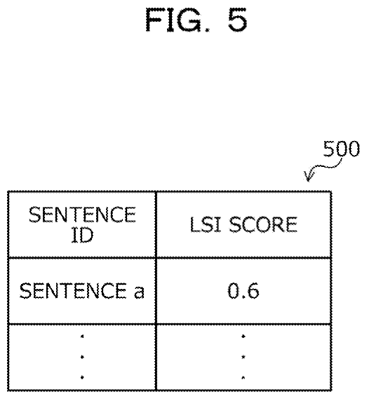

Next, an example of content stored in the LSI score list 500 will be described with reference to FIG. 5. The LSI score list 500 is implemented by, for example, a storage area of the memory 302, the recording medium 305, or the like of the specifying device 100 illustrated in FIG. 3.

FIG. 5 is an explanatory diagram illustrating an example of content stored in the LSI score list 500. As illustrated in FIG. 5, the LSI score list 500 has fields for sentence ID and LSI score. In the LSI score list 500, LSI score information is stored as a record by setting information in each field for each sentence. In the field for sentence ID, a sentence ID assigned to a sentence and specifying the sentence is set. In the field for LSI score, an LSI score indicating the similarity by the LSI between the input sentence and the sentence identified by the sentence ID is set.

(Content Stored in WMD Score List 600)

Next, an example of content stored in the WMD score list 600 will be described with reference to FIG. 6. The WMD score list 600 is implemented by, for example, a storage area of the memory 302, the recording medium 305, or the like of the specifying device 100 illustrated in FIG. 3.

FIG. 6 is an explanatory diagram illustrating an example of content stored in a WMD score list 600. As illustrated in FIG. 6, the WMD score list 600 has fields for sentence ID and WMD score. In the WMD score list 600, WMD score information is stored as a record by setting information in each field for each sentence. In the field for sentence ID, a sentence ID assigned to a sentence and specifying the sentence is set. In the field for WMD score, a WMD score indicating the similarity by the WMD between the input sentence and the sentence identified by the sentence ID is set.

(Content Stored in Similarity Score List 700)

Next, an example of content stored in the similarity score list 700 will be described with reference to FIG. 7. The similarity score list 700 is implemented by, for example, a storage area of the memory 302, the recording medium 305, or the like of the specifying device 100 illustrated in FIG. 3.

FIG. 7 is an explanatory diagram illustrating an example of content stored in the similarity score list 700. As illustrated in FIG. 7, the similarity score list 700 has fields for sentence ID and similarity score. In the similarity score list 700, similarity score information is stored as a record by setting information in each field for each sentence. In the field for sentence ID, a sentence ID assigned to a sentence and specifying the sentence is set. In the field for similarity score, a similarity score indicating the similarity based on the LSI score and the WMD score between the input sentence and the sentence identified by the sentence ID is set.

(Hardware Configuration Example of Client Device 201)

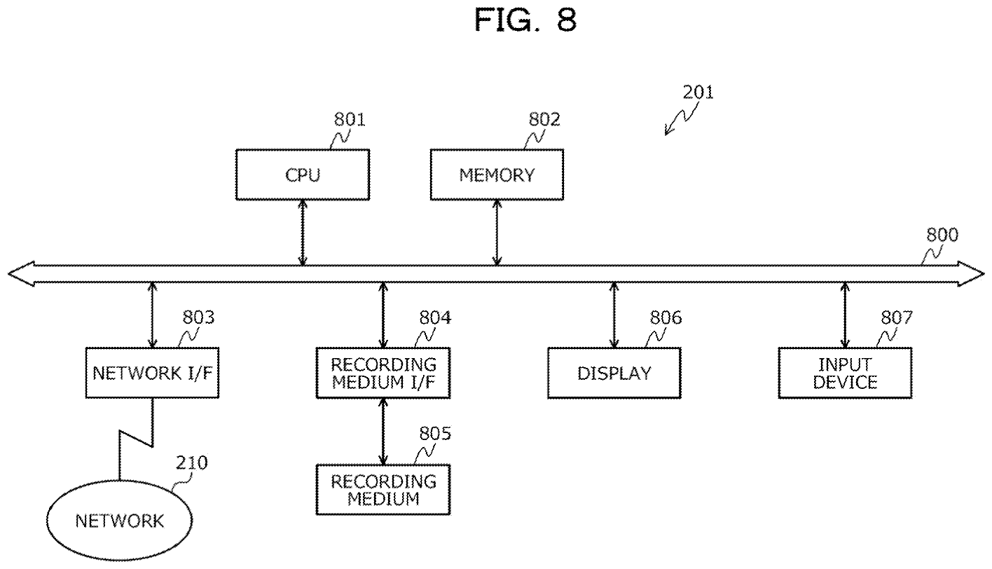

Next, a hardware configuration example of the client device 201 included in the FAQ system 200 illustrated in FIG. 2 will be described with reference to FIG. 8.

FIG. 8 is a block diagram illustrating a hardware configuration example of the client device 201. In FIG. 8, the client device 201 includes a CPU 801, a memory 802, a network I/F 803, a recording medium I/F 804, a recording medium 805, a display 806, and an input device 807. Furthermore, the individual components are connected to each other by, for example, a bus 800.

Here, the CPU 801 performs overall control of the client device 201. The memory 802 includes, for example, a ROM, a RAM, a flash ROM, and the like. Specifically, for example, the flash ROM or the ROM stores various types of programs, while the RAM is used as a work area for the CPU 801. The programs stored in the memory 802 are loaded into the CPU 801 to cause the CPU 801 to execute coded processing.

The network I/F 803 is connected to the network 210 through a communication line, and is connected to another computer through the network 210. Then, the network I/F 803 manages an interface between the network 210 and an inside, and controls input and output of data to and from another computer. For example, the network I/F 803 is a modem, a LAN adapter, or the like.

The recording medium I/F 804 controls reading and writing of data from and to the recording medium 805 under the control of the CPU 801. The recording medium I/F 804 is, for example, a disk drive, an SSD, a USB port, or the like. The recording medium 805 is a nonvolatile memory that stores data written under the control of the recording medium I/F 804. For example, the recording medium 805 is a disk, a semiconductor memory, a USB memory, or the like. The recording medium 805 may be attached to and detached from the client device 201.

The display 806 displays data such as a document, an image, and function information, as well as a cursor, an icon, or a tool box. The display 806 is, for example, a cathode ray tube (CRT), a liquid crystal display, an organic electroluminescence (EL) display, or the like. The input device 807 has keys for inputting characters, numbers, various instructions, and the like, and inputs data. The input device 807 may be a keyboard, a mouse, or the like, or may be a touch-panel input pad, a numeric keypad, or the like.

The client device 201 may include, for example, a printer, a scanner, a microphone, a speaker, and the like, in addition to the above-described components. Furthermore, the client device 201 may include, for example, a plurality of the recording medium I/Fs 804 and the recording media 805. Furthermore, the client device 201 needs not include, for example, the recording medium I/F 804 and the recording medium 805.

(Functional Configuration Example of Specifying Device 100)

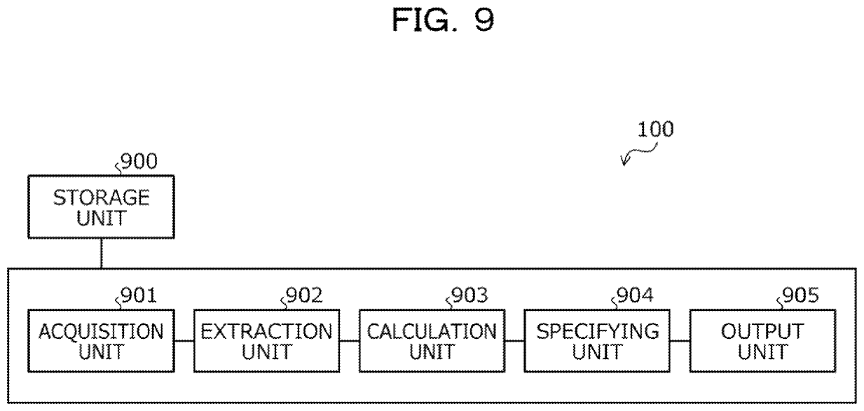

Next, a functional configuration example of the specifying device 100 will be described with reference to FIG. 9.

FIG. 9 is a block diagram illustrating a functional configuration example of the specifying device 100. The specifying device 100 includes a storage unit 900, an acquisition unit 901, an extraction unit 902, a calculation unit 903, a specifying unit 904, and an output unit 905.

The storage unit 900 is implemented by, for example, a storage area of the memory 302, the recording medium 305 illustrated in FIG. 3, or the like. Hereinafter, a case in which the storage unit 900 is included in the specifying device 100 will be described, but the present embodiment is not limited to the case. For example, there may be a case where the storage unit 900 is included in a device different from the specifying device 100, and content stored in the storage unit 900 can be referred to by the specifying device 100.

The acquisition unit 901 to the output unit 905 function as an example of a control unit. Specifically, for example, the acquisition unit 901 to the output unit 905 implement functions thereof by causing the CPU 301 to execute a program stored in the storage area of the memory 302, the recording medium 305, or the like illustrated in FIG. 3 or by the network I/F 303. A processing result of each functional unit is stored in the storage area of the memory 302, the recording medium 305, or the like illustrated in FIG. 3, for example.

The storage unit 900 stores various types of information referred to or updated in the processing of each functional unit. The storage unit 900 stores a plurality of sentences. The sentence is, for example, a question sentence associated with an answer sentence. The sentence is, for example, a sentence. The sentence may be, for example, a series of words. The sentence is written in Japanese, for example. The sentence may be written in a language other than Japanese, for example. Furthermore, the storage unit 900 may store an inverted index for each sentence.

The storage unit 900 stores a model based on Word2Vec. The model based on Word2Vec is generated on the basis of, for example, at least one of the Japanese version Wikipedia or the plurality of sentences stored in the storage unit 900. In the following description, the model based on Word2Vec may be referred to as “Word2Vec model”.

The storage unit 900 stores a model based on the LSI. The model based on the LSI is generated on the basis of, for example, a plurality of sentences stored in the storage unit 900. In the following description, the model based on the LSI may be referred to as “LSI model”. Furthermore, the storage unit 900 stores a dictionary based on the LSI. In the following description, the dictionary based on the LSI may be referred to as “LSI dictionary”. Furthermore, the storage unit 900 stores a corpus based on the LSI. In the following description, the corpus based on the LSI may be referred to as “LSI corpus”.

The acquisition unit 901 acquires various types of information to be used for the processing of each functional unit. The acquisition unit 901 stores the acquired various types of information in the storage unit 900 or outputs the acquired various types of information to each function unit. Furthermore, the acquisition unit 901 may output the various types of information stored in the storage unit 900 to each function unit. The acquisition unit 901 acquires the various types of information on the basis of, for example, the user's operation input. The acquisition unit 901 may receive the various types of information from a device different from the specifying device 100, for example.

The acquisition unit 901 acquires the first sentence. The first sentence is, for example, a question sentence. The first sentence is, for example, a sentence. The first sentence may be, for example, a series of words. The first sentence is written in Japanese. The first sentence may be written in a language other than Japanese, for example. The acquisition unit 901 receives the first sentence from the client device 201, for example.

The extraction unit 902 extracts a plurality of sentences including the same words as the first sentence from the storage unit 900. The extraction unit 902 generates an inverted index for each sentence stored in the storage unit 900 and stores the inverted index in the storage unit 900. The extraction unit 902 generates an inverted index of the acquired first sentence, compares the generated inverted index with the inverted index of each sentence stored in the storage unit 900, and calculates a score according to frequencies of appearance of the words for each sentence stored in the storage unit 900. Then, the extraction unit 902 extracts a plurality of sentences from the storage unit 900 on the basis of the calculated score. Thereby, the extraction unit 902 can reduce the number of sentences to be processed by the calculation unit 903, and can reduce the processing amount of the calculation unit 903.

The calculation unit 903 calculates and acquires a first value indicating a result of the WMD between each sentence and the input first sentence for each sentence of a plurality of sentences stored in the storage unit 900. The first value is, for example, the WMD score. The plurality of sentences is, for example, the plurality of sentences extracted by the extraction unit 902. The plurality of sentences may be, for example, all of sentences stored in the storage unit 900.

The calculation unit 903 calculates and acquires the WMD score of each sentence of the plurality of sentences extracted by the extraction unit 902 and the input first sentence, using, for example, the Word2Vec model. Thereby, the calculation unit 903 can use the WMD score when calculating the similarity score indicating the semantic similarity between each sentence of the plurality of sentences extracted by the extraction unit 902 and the input first sentence.

The calculation unit 903 acquires the second value indicating a result of the LSI between each sentence and the first sentence for each sentence of the plurality of sentences stored in the storage unit 900. The second value is, for example, the LSI score. The plurality of sentences is, for example, the plurality of sentences extracted by the extraction unit 902. The plurality of sentences may be, for example, all of sentences stored in the storage unit 900.

The calculation unit 903 calculates and acquires the LSI score of each sentence of the plurality of sentences extracted by the extraction unit 902 and the input first sentence, using, for example, the LSI model. Thereby, the calculation unit 903 can use the LSI score when calculating the similarity score indicating the semantic similarity between each sentence of the plurality of sentences extracted by the extraction unit 902 and the input first sentence.

Furthermore, the calculation unit 903 may calculate and acquire the LSI score of each sentence of remaining sentences stored in the storage unit 900 other than the plurality of sentences extracted by the extraction unit 902 and the input first sentence, using, for example, the LSI model. Thereby, the calculation unit 903 can allow the specifying unit 904 to refer to the LSI score for each sentence of the remaining sentences.

In a case where the second value acquired for any of the plurality of sentences is a negative value, the calculation unit 903 may correct the second value acquired for any of the sentences to 0. For example, in a case where the LSI score acquired for any sentence is a negative value, the calculation unit 903 corrects the LSI score for the sentence to 0. Thereby, the calculation unit 903 can easily calculate the similarity score with high accuracy.

The calculation unit 903 calculates the similarity between each sentence of the plurality of sentences stored in the storage unit 900 and the first sentence on the basis of the vector corresponding to the sentence. The similarity is, for example, the similarity score. The similarity can accurately indicate how much any sentence and the first sentence are semantically similar. The plurality of sentences is, for example, the plurality of sentences extracted by the extraction unit 902. The plurality of sentences may be, for example, all of sentences stored in the storage unit 900.

The vector corresponding to a sentence has the magnitude based on the first value acquired for the sentence and the orientation based on the second value acquired for the sentence. The vector corresponding to a sentence has, for example, the magnitude based on the first value acquired for the sentence and an angle based on the second value acquired for the sentence with reference to a first axis of a predetermined coordinate system. The predetermined coordinate system is, for example, a plane coordinate system, and the first axis is, for example, an X axis.

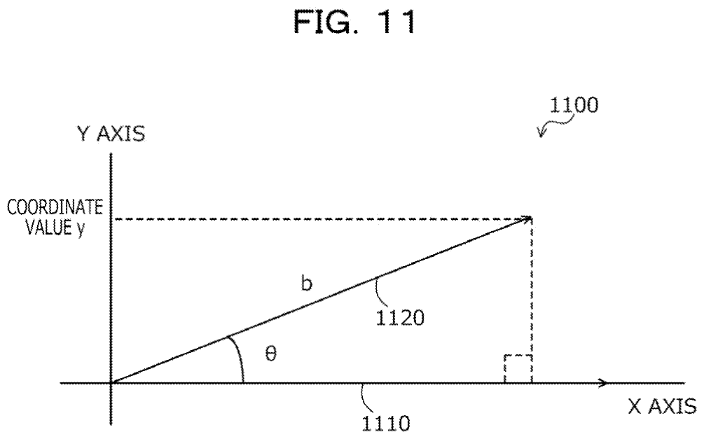

The calculation unit 903 calculates the similarity between each sentence and the first sentence on the basis of, for example, a coordinate value of the vector corresponding to the sentence on a second axis of the predetermined coordinate system, the second axis being different from the first axis. The second axis is, for example, a Y axis. Specifically, the calculation unit 903 calculates a Y coordinate value of the vector corresponding to each sentence as the similarity score between the sentence and the first sentence. Specifically, an example of calculating the similarity score will be described below with reference to, for example, FIG. 11. Thereby, the calculation unit 903 can allow the specifying unit 904 to refer to the similarity score serving as an index for specifying the second sentence semantically similar to the first sentence from the storage unit 900.

In a case where the second value acquired for any of a plurality of sentences is less than a threshold value, the calculation unit 903 calculates the similarity between each sentence and the first sentence on the basis of the vector corresponding to the sentence. The plurality of sentences is, for example, the plurality of sentences extracted by the extraction unit 902. The plurality of sentences may be, for example, all of sentences stored in the storage unit 900. The threshold value is, for example, 0.9. For example, in a case where an LSI score maximum value is less than the threshold value of 0.9 among the LSI scores calculated for respective sentences of a plurality of sentences, the calculation unit 903 calculates the similarity score on the basis of the vector corresponding to each sentence.

Meanwhile, for example, in a case where the LSI score maximum value is equal to or larger than the threshold value of 0.9 among the LSI scores calculated for respective sentences of a plurality of sentences, the calculation unit 903 may omit the processing of calculating the similarity score. Furthermore, in this case, the calculation unit 903 may omit the processing of calculating the first value. Thereby, in a case where the second value is relatively large, and it can be determined that the specifying unit 904 can accurately specify the second sentence semantically similar to the first sentence from the storage unit 900 on the basis of the second value, the calculation unit 903 does not calculate the similarity score, thereby reducing the processing amount.

The specifying unit 904 specifies the second sentence similar to the first sentence from the storage unit 900 on the basis of the similarity between each sentence of a plurality of sentences stored in the calculated storage unit 900 and the first sentence. The plurality of sentences is, for example, the plurality of sentences extracted by the extraction unit 902. The plurality of sentences may be, for example, all of sentences stored in the storage unit 900.

The specifying unit 904 specifies the second sentence having the largest calculated similarity among the plurality of sentences stored in the storage unit 900, for example. Specifically, the specifying unit 904 specifies the sentence having the maximum calculated similarity score from among the plurality of sentences extracted by the extraction unit 902, as the second sentence. Thereby, the specifying unit 904 can accurately specify the second sentence semantically similar to the first sentence.

The specifying unit 904 may specify, for example, the second sentence having the calculated similarity that is equal to or larger than a predetermined value among the plurality of sentences stored in the storage unit 900. Here, there may be a plurality of the second sentences. Specifically, the specifying unit 904 specifies the sentence having the calculated similarity score that is equal to or larger than a predetermined value from the plurality of sentences extracted by the extraction unit 902, as the second sentence. Thereby, the specifying unit 904 can accurately specify the second sentence semantically similar to the first sentence.

The specifying unit 904 may specify, for example, the second sentence similar to the first sentence from the storage unit 900 on the basis of the similarity between each sentence of the plurality of extracted sentences and the first sentence, and the second value acquired for each sentence of the remaining sentences. Specifically, the specifying unit 904 specifies a sentence corresponding to the largest score among the similarity score for each sentence of the plurality of extracted sentences and the LSI score for each sentence of the remaining scores, as the second sentence. Thereby, the specifying unit 904 can accurately specify the second sentence semantically similar to the first sentence.

Specifically, the specifying unit 904 may specify a sentence corresponding to a score having a predetermined value or larger among the similarity score for each sentence of the plurality of extracted sentences and the LSI score for each sentence of the remaining scores, as the second sentence. Here, there may be a plurality of the second sentences. Thereby, the specifying unit 904 can accurately specify the second sentence semantically similar to the first sentence.

In a case where the second value acquired for any of a plurality of sentences stored in the storage unit 900 is equal to or larger than the threshold value, the specifying unit 904 may specify the second sentence from the storage unit 900 on the basis of the second value acquired for each sentence. The plurality of sentences is, for example, the plurality of sentences extracted by the extraction unit 902. The plurality of sentences may be, for example, all of sentences stored in the storage unit 900.

For example, in a case where the LSI score maximum value is equal to or larger than the threshold value of 0.9 among the LSI scores calculated for respective sentences of a plurality of sentences extracted by the extraction unit 902, the specifying unit 904 specifies the second sentence from the storage unit 900 on the basis of the LSI scores. Specifically, the specifying unit 904 specifies the sentence having the maximum LSI score from among the plurality of sentences extracted by the extraction unit 902, as the second sentence. Thereby, the specifying unit 904 can accurately specify the second sentence semantically similar to the first sentence.

Specifically, the specifying unit 904 may specify the sentence having the LSI score that is equal to or larger than a predetermined value from the plurality of sentences extracted by the extraction unit 902, as the second sentence. Here, there may be a plurality of the second sentences. Thereby, the specifying unit 904 can accurately specify the second sentence semantically similar to the first sentence.

The specifying unit 904 may sort a plurality of sentences stored in the storage unit 900 on the basis of the calculated similarity between each sentence of the plurality of sentences stored in the storage unit 900 and the first sentence. The plurality of sentences is, for example, the plurality of sentences extracted by the extraction unit 902. The plurality of sentences may be, for example, all of sentences stored in the storage unit 900. The specifying unit 904 sorts, for example, the plurality of sentences extracted by the extraction unit 902 in descending order of the calculated similarity score. Thereby, the specifying unit 904 can sort a plurality of sentences in the order of being semantically similar to the first sentence.

The specifying unit 904 may, for example, sort sentences stored in the storage unit 900 on the basis of the similarity between each sentence of the plurality of extracted sentences and the first sentence, and the second value acquired for each sentence of the remaining sentences. Specifically, the specifying unit 904 sorts the sentences stored in the storage unit 900 in descending order of the score on the basis of the similarity score for each sentence of the plurality of extracted sentences and the LSI score for each sentence of the remaining scores. Thereby, the specifying unit 904 can sort a plurality of sentences in the order of being semantically similar to the first sentence.

In the case where the second value acquired for any of a plurality of sentences stored in the storage unit 900 is equal to or larger than the threshold value, the specifying unit 904 may sort the sentences stored in the storage unit 900 on the basis of the second value acquired for each sentence. The plurality of sentences is, for example, the plurality of sentences extracted by the extraction unit 902. The plurality of sentences may be, for example, all of sentences stored in the storage unit 900.

For example, in the case where the LSI score maximum value is equal to or larger than the threshold value of 0.9 among the LSI scores calculated for the respective sentences of the plurality of sentences extracted by the extraction unit 902, the specifying unit 904 sorts the plurality of sentences extracted by the extraction unit 902 on the basis of the LSI scores. Specifically, the specifying unit 904 sorts the plurality of sentences extracted by the extraction unit 902 in descending order of the LSI score. Thereby, the specifying unit 904 can sort a plurality of sentences in the order of being semantically similar to the first sentence.

The output unit 905 outputs various types of information. An output format is, for example, display on a display, print output to a printer, transmission to an external device by the network I/F 303, or storage in the storage area of the memory 302, the recording medium 305, or the like. The output unit 905 outputs a processing result of one of the function units. Thereby, the output unit 905 enables a processing result of any of the functional units to be notified to the user of the specifying device 100, thereby improving the convenience of the specifying device 100.

The output unit 905 outputs the specified second sentence. For example, the output unit 905 transmits the specified second sentence to the client device 201, and causes the client device 201 to display the second sentence. Thereby, the output unit 905 can enable the user of the client device 201 to recognize the second sentence semantically similar to the first sentence and can improve the convenience.

The output unit 905 outputs an answer sentence associated with the specified second sentence. For example, the output unit 905 transmits the answer sentence associated with the specified second sentence to the client device 201, and causes the client device 201 to display the answer sentence associated with the specified second sentence. Thereby, the output unit 905 can enable the user of the client device 201 to recognize the answer sentence associated with the second sentence semantically similar to the first sentence, can implement a service for providing an FAQ, and can improve the convenience.

The output unit 905 outputs a result of sorting by the specifying unit 904. For example, the output unit 905 transmits the result sorting by the specifying unit 904 to the client device 201, and causes the client device 201 to display the result of sorting by the specifying unit 904. Thereby, the output unit 905 can enable the user of the client device 201 to recognize the sentences stored in the storage unit 900 in descending order of the degree of being semantically similar to the first sentence, and can improve the convenience of the FAQ system 200.

Here, a case in which the calculation unit 903 calculates the first value and the second value between each sentence of the plurality of sentences and the input first sentence has been described, but the present embodiment is not limited to the case. For example, the acquisition unit 901 may acquire the first value and the second value from a device that calculates the first value and the second value between each sentence of the plurality of sentences and the input first sentence. In this case, the acquisition unit 901 does not need to acquire the first sentence.

In this case, the acquisition unit 901 acquires a first value indicating a result of the WMD between each sentence and the input first sentence for each sentence of a plurality of sentences stored in the storage unit 900. The first value is, for example, the WMD score. The plurality of sentences is, for example, the plurality of sentences extracted by the extraction unit 902. The plurality of sentences may be, for example, all of sentences stored in the storage unit 900. The acquisition unit 901 acquires the WMD score from, for example, an external computer. Thereby, the acquisition unit 901 can calculate the similarity between each sentence of the plurality of sentences stored in the storage unit 900 and the first sentence without the specifying device 100 calculating the first value.

The acquisition unit 901 acquires a second value indicating a result of the LSI between each sentence and the first sentence for each sentence of a plurality of sentences stored in the storage unit 900. The second value is, for example, the LSI score. The plurality of sentences is, for example, the plurality of sentences extracted by the extraction unit 902. The plurality of sentences may be, for example, all of sentences stored in the storage unit 900. The acquisition unit 901 acquires the LSI score from, for example, an external computer. Thereby, the acquisition unit 901 can calculate the similarity between each sentence of the plurality of sentences stored in the storage unit 900 and the first sentence without the specifying device 100 calculating the second value.

In a case where the second value acquired for any of the plurality of sentences is a negative value, the acquisition unit 901 may correct the second value acquired for any of the sentences to 0. For example, in a case where the LSI score acquired for any sentence is a negative value, the acquisition unit 901 corrects the LSI score for the sentence to 0. As a result, the acquisition unit 901 can easily calculate the similarity score for any sentence with high accuracy.

Here, a case in which the specifying device 100 includes the extraction unit 902 has been described but the embodiment is not limited to the case. For example, the specifying device 100 may not include the extraction unit 902. Here, a case in which the specifying device 100 includes the specifying unit 904 has been described but the embodiment is not limited to the case. For example, the specifying device 100 may not include the specifying unit 904. In this case, the specifying device 100 may transmit the calculation result of the calculation unit 903 to an external computer having the function of the specifying unit 904.

(Operation Example of Specifying Device 100)

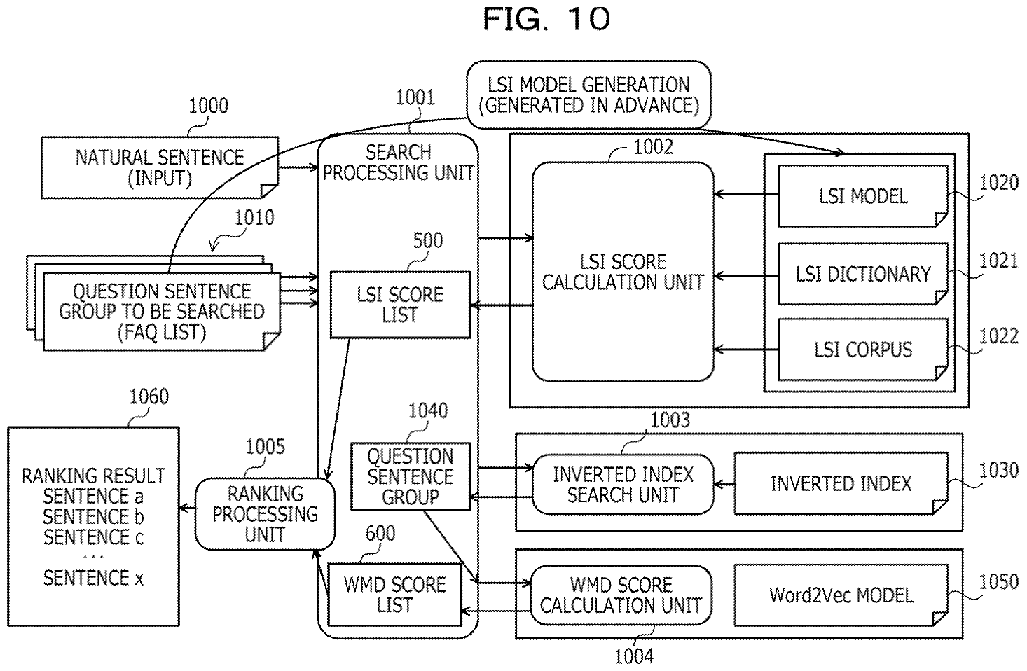

Next, an operation example of the specifying device 100 will be described with reference to FIGS. 10 to 18. First, a specific functional configuration example of the specifying device 100 in an operation example will be described with reference to FIG. 10.

FIG. 10 is a block diagram illustrating a specific functional configuration example of the specifying device 100. The specifying device 100 includes a search processing unit 1001, an LSI score calculation unit 1002, an inverted index search unit 1003, a WMD score calculation unit 1004, and a ranking processing unit 1005.

The search processing unit 1001 to the ranking processing unit 1005 can implement, for example, the acquisition unit 901 to the output unit 905 illustrated in FIG. 9. Specifically, for example, functions of the search processing unit 1001 to the ranking processing unit 1005 are implemented by causing the CPU 301 to execute a program stored in the storage area of the memory 302, the recording medium 305, or the like illustrated in FIG. 3 or by the network I/F 303.

The search processing unit 1001 accepts an input of a natural sentence 1000. The search processing unit 1001 receives, for example, the natural sentence 1000 from the client device 201. Then, the search processing unit 1001 outputs the input natural sentence 1000 to the LSI score calculation unit 1002, the inverted index search unit 1003, and the WMD score calculation unit 1004. In the following description, the input natural sentence 1000 may be referred to as “input sentence a”.

The search processing unit 1001 acquires a question sentence group 1010 to be searched from the FAQ list 400. Then, the search processing unit 1001 outputs the question sentence group 1010 to be searched to the LSI score calculation unit 1002 and the inverted index search unit 1003. The search processing unit 1001 receives a question sentence group 1040 extracted by the inverted index search unit 1003 out of the question sentence group 1010 to be searched, and transfers the extracted question sentence group 1040 to the WMD score calculation unit 1004. In the following description, a single question sentence to be searched for may be referred to as “question sentence b”.

The search processing unit 1001 receives the LSI score list 500 generated by the LSI score calculation unit 1002 and transfers the LSI score list 500 to the ranking processing unit 1005. The search processing unit 1001 receives the WMD score list 600 generated by the WMD score calculation unit 1004 and transfers the WMD score list 600 to the ranking processing unit 1005. Specifically, the search processing unit 1001 can implement the acquisition unit 901 illustrated in FIG. 9.

The LSI score calculation unit 1002 calculates an LSI score between the received input sentence a and each question sentence b of the received question sentence group 1010 on the basis of an LSI model 1020, an LSI dictionary 1021, and an LSI corpus 1022. The LSI score calculation unit 1002 may generate the LSI model 1020 in advance on the basis of the question sentence group 1010. The LSI score calculation unit 1002 outputs the LSI score list 500 associated with the calculated LSI score to the search processing unit 1001 for each question sentence b. Specifically, the LSI score calculation unit 1002 implements the calculation unit 903 illustrated in FIG. 9.

The inverted index search unit 1003 generates an inverted index of the received input sentence a, compares the input sentence a with an inverted index 1030 corresponding to each question sentence b of the question sentence group 1010, and calculates a score of the each question sentence b of the question sentence group 1010. The inverted index search unit 1003 extracts the question sentence group 1040 from the question sentence group 1010 on the basis of the calculated score, and outputs the question sentence group 1040 to the search processing unit 1001. Specifically, the inverted index search unit 1003 implements the extraction unit 902 illustrated in FIG. 9.

The WMD score calculation unit 1004 calculates a WMD score between the received input sentence a and each question sentence b of the received question sentence group 1040 on the basis of a Word2Vec model 1050. The WMD score calculation unit 1004 may generate the Word2Vec model 1050 in advance on the basis of the Japanese version Wikipedia and the question sentence group 1010. The WMD score calculation unit 1004 outputs the WMD score list 600 associated with the calculated WMD score to the search processing unit 1001 for each question sentence b. Specifically, the WMD score calculation unit 1004 implements the calculation unit 903 illustrated in FIG. 9.

The ranking processing unit 1005 calculates a similarity score s between the input sentence a and each question sentence b of the question sentence group 1040 on the basis of the received LSI score list 500 and WMD score list 600. An example of calculating the similarity score s will be described below with reference to FIG. 11. The ranking processing unit 1005 adopts the LSI score as it is for the similarity score s between the input sentence a and each question sentence b of the question sentence group 1010 other than the question sentence group 1040. The ranking processing unit 1005 sorts the question sentences b of the question sentence group 1010 in descending order of the similarity score s.

The ranking processing unit 1005 specifies the question sentence b semantically similar to the input sentence a on the basis of a sorting result 1060, and causes the client device 201 to display the answer sentence associated with the specified question sentence b in the FAQ list 400. The ranking processing unit 1005 may causes the client device 201 to display the sorting result 1060. Specifically, the ranking processing unit 1005 implements the calculation unit 903, the specifying unit 904, and the output unit 905 illustrated in FIG. 9.

Thereby, the specifying device 100 can calculate the similarity score s accurately indicating how much the input sentence a and the question sentence b are semantically similar even when the number of sentences serving as training data prepared by the user is relatively small. Since the specifying device 100 generates, for example, the Word2Vec model 1050 on the basis of the Japanese version of Wikipedia and the question sentence group 1010, the user can avoid preparing a sentence serving as training data. Furthermore, since the specifying device 100 generates, for example, the LSI model 1020 on the basis of the question sentence group 1010, the specifying device 100 can reduce the workload for the user to prepare a sentence to serve as training data.

Furthermore, the specifying device 100 can calculate the similarity score s accurately indicating how much the input sentence a and the question sentence b are semantically similar even when the number of types of learning parameters is relatively small. For example, when generating the LSI model 1020, the specifying device 100 simply adjusts one type of learning parameter indicating the number of dimensions, and can suppress an increase in cost and workload. Furthermore, the specifying device 100 can generate the LSI model 1020 in a relatively short time, and can suppress an increase in cost and workload. Furthermore, the specifying device 100 can use the learning parameters related to WMD in a fixed manner, and can suppress an increase in cost and workload.

Furthermore, the specifying device 100 can calculate the similarity score s accurately indicating how much the input sentence a and the question sentence b are semantically similar even when an unknown word is included in the input sentence a. Since the specifying device 100 uses, for example, the WMD score between the input sentence a and the question sentence b, the accuracy of calculating the similarity score s can be improved even if an unknown word is included in the input sentence a.

Furthermore, the specifying device 100 can calculate the similarity score s accurately indicating how much the input sentence a and the question sentence b are semantically similar even in the Japanese environment. As a result, the specifying device 100 can improve the probability of succeeding in specifying the question sentence b semantically similar to the input sentence a from the question sentence group 1010. Next, an example in which the specifying device 100 calculates the similarity score between the input sentence a and the question sentence b will be described with reference to FIG. 11.

FIG. 11 is an explanatory diagram illustrating an example of calculating the similarity score. In the example of FIG. 11, a vector 1110 corresponding to the input sentence a, the vector 1110 having the same orientation as the X axis and magnitude 1, is defined on a coordinate system 1100. A vector 1120 corresponding to the question sentence b, the vector 1120 having an orientation of an angle θ with respect to the X axis and magnitude b, where m=the LSI score is defined, b=the WMD score is defined, and cos θ=m is defined, is defined on the coordinate system 1100.

Here, it is defined that, on the coordinate system 1100, the closer the vectors 1110 and 1120 are to the same direction, the larger the semantic similarity score between the input sentence a and the question sentence b. The closeness of the vectors 1110 and 1120 is represented by, for example, a Y coordinate value of the vector 1120. For example, the closer the Y coordinate value of the vector 1120 is to 0, the closer the vectors 1110 and 1120 are to the same direction, and the larger the semantic similarity score between the input sentence a and the question sentence b.

Therefore, the specifying device 100 calculates the semantic similarity score between the input sentence a and the question sentence b on the basis of the Y coordinate value of the vector 1120. The specifying device 100 calculates, for example, a Y coordinate value y=√{(b\hat{ }2)×(1−m\hat{ }2)}, and calculates the semantic similarity score s between the input sentence a and the question sentence b s=1/(1+y).

Thereby, the specifying device 100 can calculate the semantic similarity score s between the input sentence a and the question sentence b so as to indicate that the closer the similarity score s to 1 in a range of 0 to 1, the more the input sentence a and the question sentence b are semantically similar. Furthermore, since the specifying device 100 calculates the similarity score s by combining the WMD score and the LSI score that are in different viewpoints, the similarity score s can accurately indicates how much the input sentence a and the question sentence b are semantically similar.

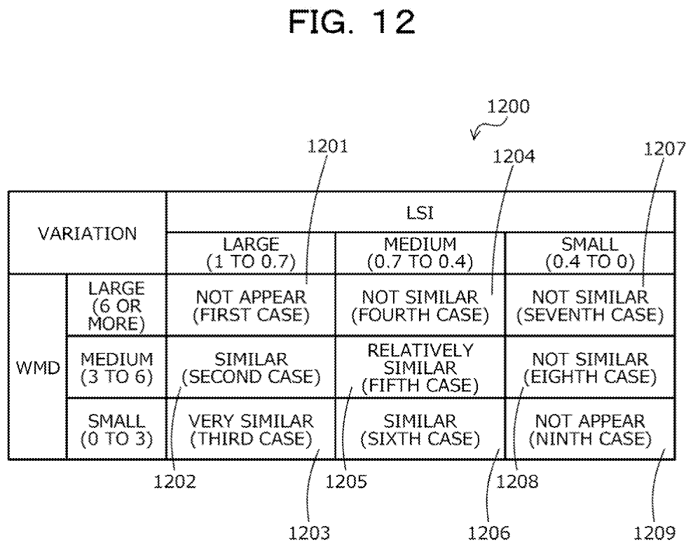

Next, an example of variations between the LSI score and the WMD score will be described with reference to FIG. 12, a relationship between the degree of semantic similarity between the input sentence a and the question sentence b and the semantic similarity score s between the input sentence a and the question sentence b will be described.

FIG. 12 is an explanatory diagram illustrating an example of variations between the LSI score and the WMD score. In FIG. 12, as illustrated in Table 1200, a first case 1201 in which the LSI score is large (1 to 0.7) and the WMD score is large (6 or more) tend not to appear for the input sentence a and the question sentence b. Therefore, in a situation where the LSI score shows the similarity but the WMD score shows dissimilarity, the specifying device 100 tends to be able to avoid calculating the similarity score, and a decrease in accuracy in calculating the similarity score tends to be avoidable.

Furthermore, as illustrated in Table 1200, a second case 1202 in which the LSI score is large (1 to 0.7) and the WMD score is medium (3 to 6) tend to appear in a case where the input sentence a and the question sentence b are semantically similar, for the input sentence a and the question sentence b. Furthermore, as illustrated in Table 1200, a third case 1203 in which the LSI score is large (1 to 0.7) and the WMD score is small (0 to 3) tend to appear in a case where the input sentence a and the question sentence b are semantically very similar, for the input sentence a and the question sentence b.

Meanwhile, since the specifying device 100 calculates the similarity score on the basis of the LSI score and the WMD score, the second case 1202 and the third case 1203, which are difficult to distinguish only by the LSI score, can be distinguished according to the similarity score. The specifying device 100 can calculate the similarity score such that the larger the LSI score or the smaller the WMD score, the larger the similarity score. Therefore, the specifying device 100 can calculate the similarity score such that the similarity score is larger in the third case 1203 than in the second case 1202. Then, the specifying device 100 can distinguish the second case 1202 and the third case 1203 according to the similarity score.

Furthermore, as illustrated in Table 1200, a fourth case 1204 in which the LSI score is medium (0.7 to 0.4) and the WMD score is large (6 or more) tend to appear in a case where the input sentence a and the question sentence b are not semantically similar, for the input sentence a and the question sentence b. Furthermore, as illustrated in Table 1200, a fifth case 1205 in which the LSI score is medium (0.7 to 0.4) and the WMD score is medium (3 to 6) tend to appear in a case where the input sentence a and the question sentence b are relatively similar, for the input sentence a and the question sentence b. Furthermore, as illustrated in Table 1200, a sixth case 1206 in which the LSI score is medium (0.7 to 0.4) and the WMD score is small (0 to 3) tend to appear in a case where the input sentence a and the question sentence b are semantically similar, for the input sentence a and the question sentence b.

Meanwhile, since the specifying device 100 calculates the similarity score on the basis of the LSI score and the WMD score, the fourth case 1204 to the sixth case 1206, which are difficult to distinguish only by the LSI score, can be distinguished according to the similarity score. The specifying device 100 can calculate the similarity score such that the larger the LSI score or the smaller the WMD score, the larger the similarity score. Therefore, the specifying device 100 can calculate the similarity score such that the similarity score is larger in the fifth case 1205 and the sixth case 1206 than in the fourth case 1204. Then, the specifying device 100 can distinguish the fourth case 1204 to the sixth case 1206 according to the similarity score.

Furthermore, as illustrated in Table 1200, a seventh case 1207 in which the LSI score is small (0.4 to 0) and the WMD score is large (6 or more) tend to appear in a case where the input sentence a and the question sentence b are not semantically similar, for the input sentence a and the question sentence b. Furthermore, as illustrated in Table 1200, an eighth case 1208 in which the LSI score is small (0.4 to 0) and the WMD score is medium (3 to 6) tend to appear in a case where the input sentence a and the question sentence b are not similar, for the input sentence a and the question sentence b.

Meanwhile, the specifying device 100 can calculate the similarity score so as to be relatively small in the seventh case 1207 and the eighth case 1208. Therefore, the specifying device 100 can accurately indicate that the input sentence a and the question sentence b are not similar by the similarity score.

Furthermore, as illustrated in Table 1200, a ninth case 1209 in which the LSI score is small (0.4 to 0) and the WMD score is small (0 to 3) tend not to appear for the input sentence a and the question sentence b. Therefore, in a situation where the LSI score shows dissimilarity but the WMD score shows the similarity, the specifying device 100 tends to be able to avoid calculating the similarity score, and a decrease in accuracy in calculating the similarity score tends to be avoidable.

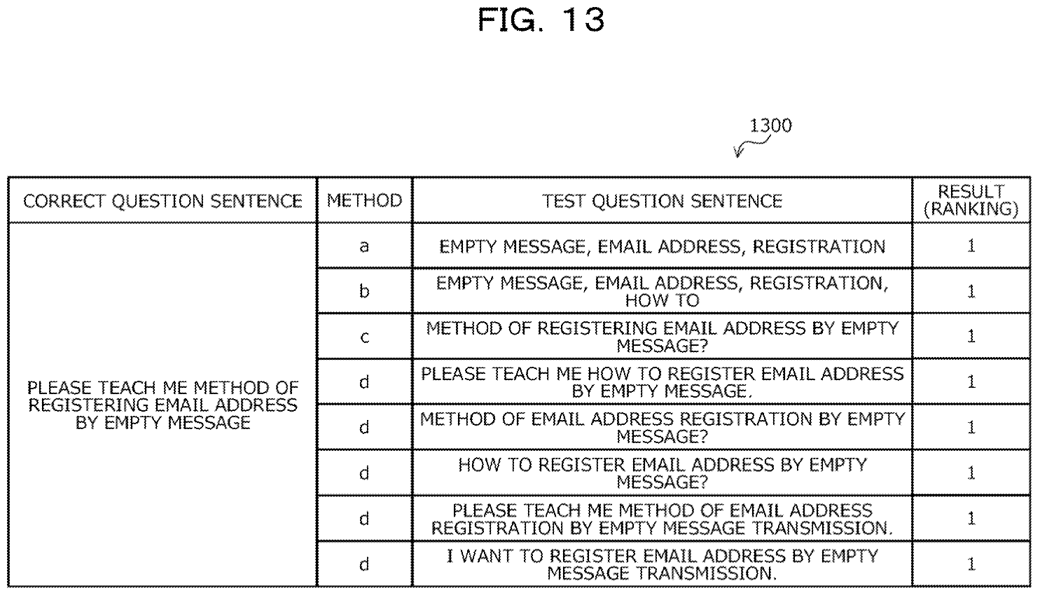

In this way, the specifying device 100 can calculate the similarity score between the input sentence a and the question sentence b so as to accurately indicate whether the input sentence a and the question sentence b are semantically similar. Then, the specifying device 100 can distinguish how much the input sentence a and the question sentence b are semantically similar. Next, effects of the specifying device 100 will be described with reference to FIGS. 13 to 17.

FIGS. 13 to 17 are explanatory diagrams illustrating the effects of the specifying device 100. In FIG. 13, as illustrated in Table 1300, the specifying device 100 uses various test question sentences as the input sentences a, and verifies whether the correct question sentences b among the question sentences b in the FAQ list 400 can be specified as up to the top three question sentences b similar to the input sentences a.

“METHOD” in Table 1300 illustrates how the test question sentence has been created. “METHOD a” indicates that the question sentence is created by a series of a plurality of words not including unknown words. “METHOD b” indicates that the question sentence is created by a series of a plurality of words including unknown words. “METHOD c” indicates that the question sentence is created by a natural sentence having the same meaning and words as the correct question sentence b. “METHOD d” indicates that the question sentence is created by a natural sentence having the same meaning as the correct question sentence b.

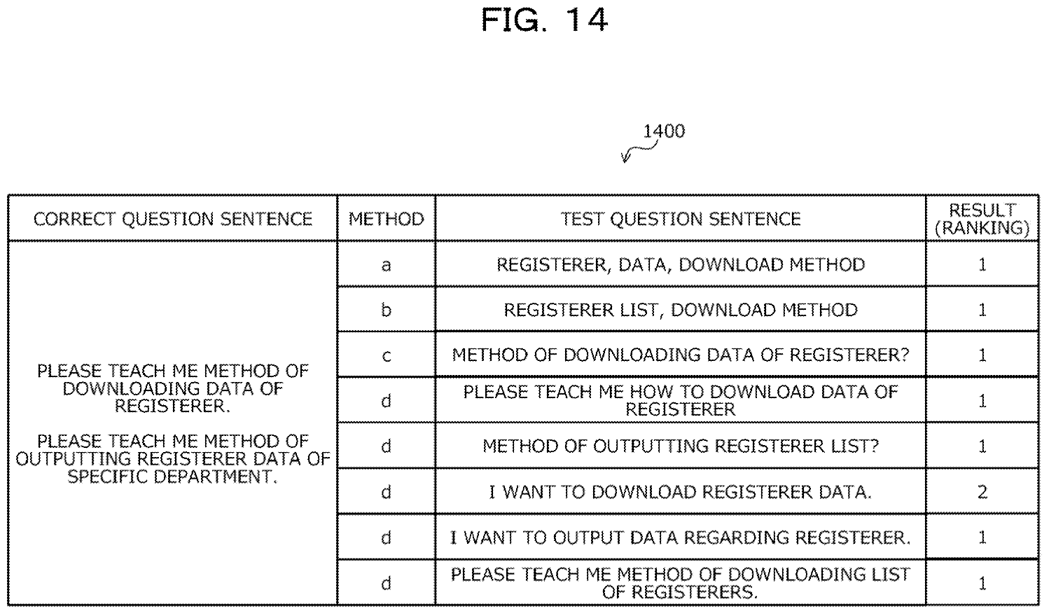

As illustrated in “RANKING” in Table 1300, the specifying device 100 can specify the correct question sentences b as up to the top three question sentences b similar to the input sentences a even in the case of using the various test question sentences as the input sentences a. Next, the description proceeds to FIG. 14.

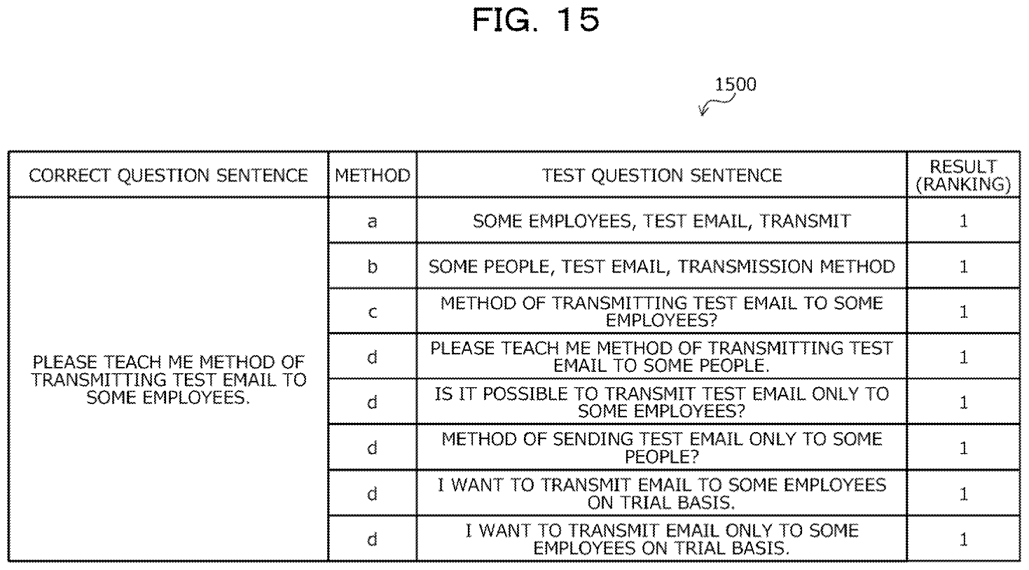

In FIG. 14, as illustrated in Table 1400, the specifying device 100 uses various test question sentences as the input sentences a, and verifies whether the correct question sentences b among the question sentences b in the FAQ list 400 can be specified as up to the top three question sentences b similar to the input sentence a. As illustrated in “RANKING” in Table 1400, the specifying device 100 can specify the correct question sentences b as up to the top three question sentences b similar to the input sentences a even in the case of using the various test question sentences as the input sentences a. Next, the description proceeds to FIG. 15.

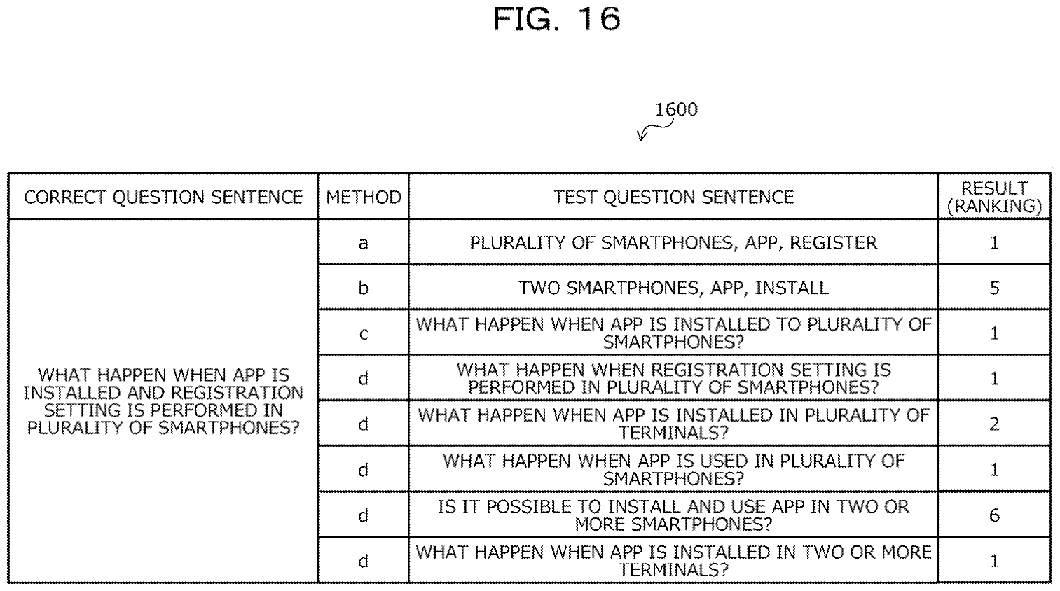

In FIG. 15, as illustrated in Table 1500, the specifying device 100 uses various test question sentences as the input sentences a, and verifies whether the correct question sentences b among the question sentences b in the FAQ list 400 can be specified as up to the top three question sentences b similar to the input sentence a. As illustrated in “RANKING” in Table 1500, the specifying device 100 can specify the correct question sentences b as up to the top three question sentences b similar to the input sentences a even in the case of using the various test question sentences as the input sentences a. Next, the description proceeds to FIG. 16.

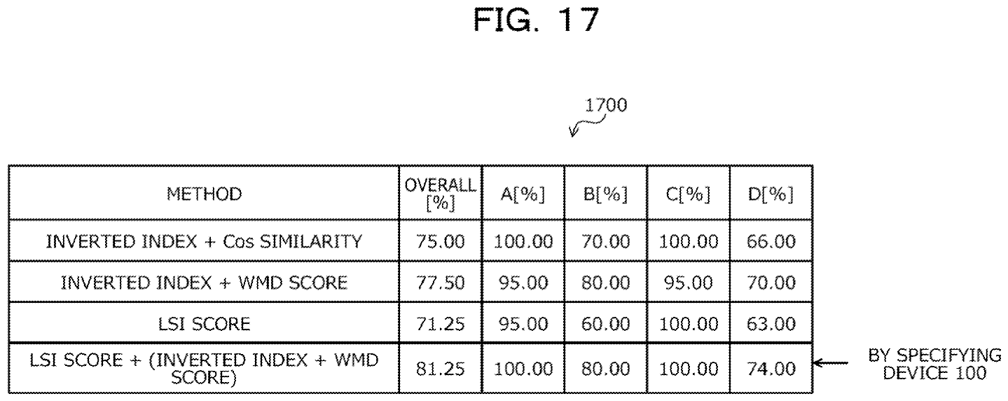

In FIG. 16, as illustrated in Table 1600, the specifying device 100 uses various test question sentences as the input sentences a, and verifies whether the correct question sentences b among the question sentences b in the FAQ list 400 can be specified as up to the top three question sentences b similar to the input sentence a. As illustrated in “RANKING” in Table 1600, the specifying device 100 can specify the correct question sentences b as up to the top three question sentences b similar to the input sentences a in the case of using the test question sentences other than two question sentences among the various test question sentences as the input sentences a. Next, the description proceeds to FIG. 17.

Table 1700 in FIG. 17 illustrates the results of comparing the probability that the specifying device 100 succeeds in specifying the correct question sentences b as up to the top three question sentences b similar to the input sentences a, with existing methods. The existing methods are, for example, “inverted index+Cos similarity”, “inverted index+WMD score”, and “LSI score”.

Table 1700 illustrates probabilities A [%] to D [%] of succeeding in specifying the correct question sentences b in the test cases A to D and the like where the various test question sentences are used as the input sentences a, as up to the top three question sentences b similar to the input sentences a. Furthermore, Table 1700 illustrates an overall percentage [%] as an average value of the probabilities A [%] to D [%] of succeeding in specifying the correct question sentences b as up to the top three question sentences b similar to the input sentences a.

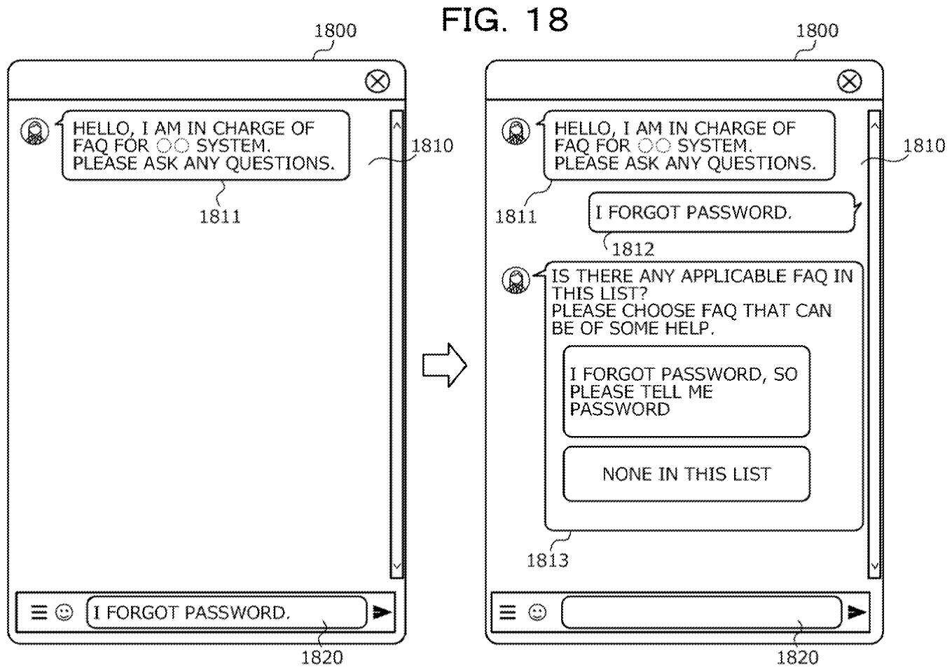

As illustrated in Table 1700, the specifying device 100 can improve the probability of succeeding in specifying the correct question sentences b as up to the top three question sentences b similar to the input sentences a, as compared with the existing methods. Furthermore, the specifying device 100 can make the average value of the probabilities of succeeding in specifying the correct question sentences b as up to the top three question sentences b similar to the input sentences a be 80% or higher, for example. Next, a display screen example in the client device 201 will be described with reference to FIG. 18.

FIG. 18 is an explanatory diagram illustrating a display screen example in the client device 201. In FIG. 18, the specifying device 100 causes the client device 201 to display an FAQ screen 1800. The FAQ screen 1800 includes a message 1811 in a conversation display field 1810 in an initial state. The message 1811 is, for example, “Hello, I am in charge of FAQ for XX system. Please ask any questions.”

The FAQ screen 1800 includes a user's input field 1820. The client device 201 transmits an input sentence input in the input field 1820 to the specifying device 100. In the example of FIG. 18, the input sentence “I forgot password” is input. The input sentence is displayed as a message 1812 in the conversation display field 1810.

The specifying device 100 calculates the similarity score and identifies a question sentence “I forgot password, so please tell me” that is semantically similar to the input sentence “I forgot password” from the FAQ list 400. The specifying device 100 further displays a message 1813 in the conversation display field 1810. The message 1813 includes, for example, “Is there any applicable FAQ in this list?” and the identified question sentence “I forgot password, so please tell me”.

In a case where the question sentence “I forgot password, so please tell me” has been clicked, the client device 201 notifies the specifying device 100 that the question sentence “I forgot my password, so please tell me” has been clicked. In response to the notification, the specifying device 100 displays an answer sentence associated with the question sentence “I forgot password, so please tell me” in the conversation display field 1810. Thereby, the specifying device 100 can implement the service for providing an FAQ.

In the above description, a case in which the orientation of the vector corresponding to the question sentence b is defined using cos θ, and the similarity score between the input sentence a and the question sentence b is defined using the Y coordinate value of the vector corresponding to the question sentence b has been described. However, the embodiment is not limited to the case. For example, the specifying device 100 may use sin θ instead of cos θ and use an X coordinate value instead of the Y coordinate value. Furthermore, the specifying device 100 may replace the LSI score and the WMD score and calculate the similarity score.

(Overall Processing Procedure)

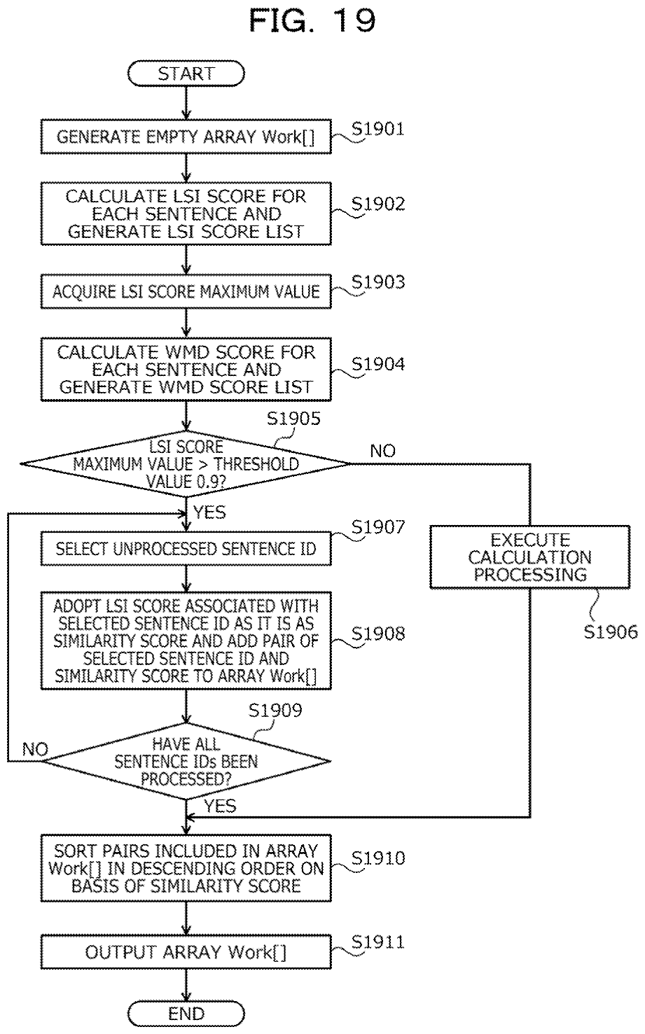

Next, an example of an overall processing procedure executed by the specifying device 100 will be described with reference to FIG. 19. The overall processing is implemented by, for example, the CPU 301, the storage area of the memory 302, the recording medium 305, or the like, and the network I/F 303 illustrated in FIG. 3.

FIG. 19 is a flowchart illustrating an example of an overall processing procedure. In FIG. 19, the specifying device 100 generates an empty array Work[ ] that stores the ranking result (step S1901). The empty array Work[ ] is implemented by, for example, the similarity score list 700.

Next, the specifying device 100 calculates the LSI score of each stored sentence with respect to an input sentence, and generates the LSI score list 500 in which the LSI score is associated with the sentence ID (step S1902). Then, the specifying device 100 acquires the LSI score maximum value from the LSI score list 500 (step S1903).

Next, the specifying device 100 calculates the WMD score between each stored sentence and an input sentence, and generates the WMD score list 600 in which the WMD score is associated with the sentence ID (step S1904). Here, the specifying device 100 may calculate the WMD score between each some sentence extracted on the basis of the inverted index, of the stored sentences, and an input sentence, and generates the WMD score list 600 in which the WMD score is associated with the sentence ID. Furthermore, the specifying device 100 does not need to calculate the WMD score for an unextracted sentence.

Then, the specifying device 100 determines whether the LSI score maximum value>the threshold value 0.9 is satisfied (step S1905). Here, in the case where the LSI score maximum value>the threshold value 0.9 is satisfied (step S1905: Yes), the specifying device 100 proceeds to the processing of step S1907. On the other hand, in the case where the LSI score maximum value>the threshold value 0.9 is not satisfied (step S1905: No), the specifying device 100 proceeds to the processing of step S1906.

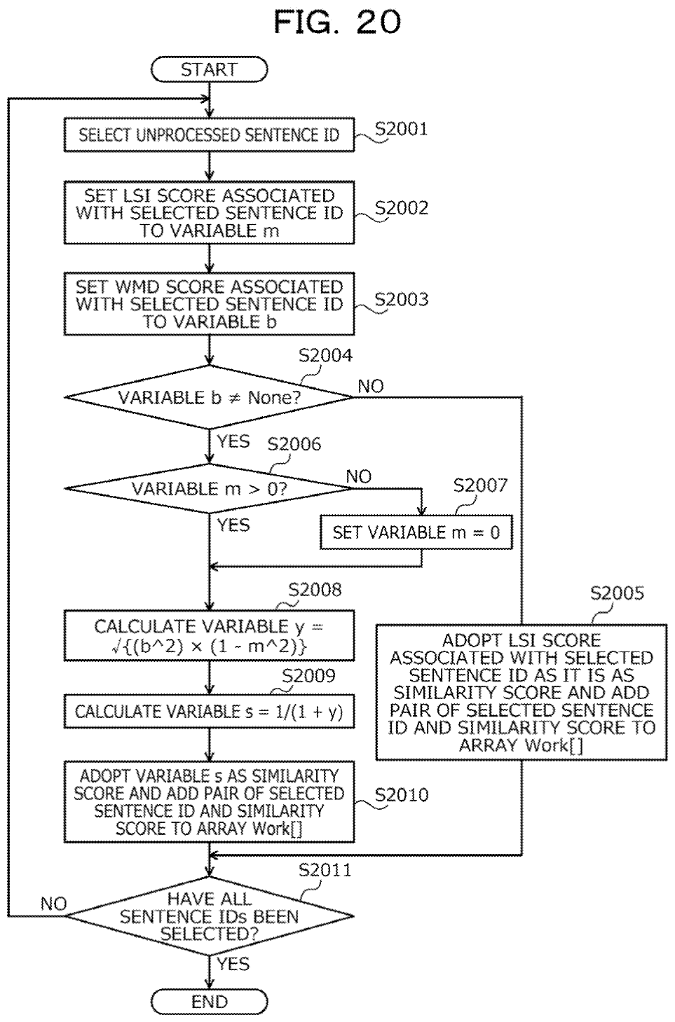

In step S1906, the specifying device 100 executes calculation processing to be described below in FIG. 20 (step S1906). Then, the specifying device 100 proceeds to the processing of step S1910.

In step S1907, the specifying device 100 selects an unprocessed sentence ID from the LSI score list 500 (step S1907). Next, the specifying device 100 adopts the LSI score associated with the selected sentence ID as it is as the similarity score, and adds a pair of the selected sentence ID and the similarity score to the array Work[ ] (step S1908).

Then, the specifying device 100 determines whether all the sentence IDs have been processed from the LSI score list 500 (step S1909). Here, in a case where there is an unprocessed sentence ID (step S1909: No), the specifying device 100 returns to the processing of step S1907. On the other hand, in a case where all the sentence IDs have been processed (step S1909: Yes), the specifying device 100 proceeds to the processing of step S1910.

In step S1910, the specifying device 100 sorts the pairs included in the array Work[ ] in descending order on the basis of the similarity score (step S1910). Next, the specifying device 100 outputs the array Work[ ] (step S1911). Then, the specifying device 100 terminates the overall processing. Thereby, the specifying device 100 can enable the user of the FAQ system 200 to recognize the sentence semantically similar to the input sentence among the stored sentences.

(Calculation Processing Procedure)

Next, an example of a calculation processing procedure executed by the specifying device 100 will be described with reference to FIG. 20. The calculation processing is implemented by, for example, the CPU 301, the storage area of the memory 302, the recording medium 305, or the like, and the network I/F 303 illustrated in FIG. 3.

FIG. 20 is a flowchart illustrating an example of a calculation processing procedure. In FIG. 20, the specifying device 100 selects an unprocessed sentence ID from the LSI score list 500 (step S2001).

Next, the specifying device 100 sets the LSI score associated with the selected sentence ID to a variable m (step S2002). Then, the specifying device 100 sets the WMD score associated with the selected sentence ID to a variable b (step S2003). Here, the specifying device 100 sets the variable b=None if there is no WMD score associated with the selected sentence ID.

Next, the specifying device 100 determines whether the variable b≠None is satisfied (step S2004). Here, in a case where the variable b≠None is satisfied (step S2004: Yes), the specifying device 100 proceeds to the processing of step S2006. On the other hand, in a case of the variable b=None is satisfied (step S2004: No), the specifying device 100 proceeds to the processing of step S2005.

In step S2005, the specifying device 100 adopts the LSI score associated with the selected sentence ID as it is as the similarity score, and adds the pair of the selected sentence ID and the similarity score to the array Work[ ] (step S2005). Then, the specifying device 100 proceeds to the processing of step S2011.

In step S2006, the specifying device 100 determines whether the variable m>0 is satisfied (step S2006). Here, in a case where the variable m>0 is satisfied (step S2006: Yes), the specifying device 100 proceeds to the processing of step S2008. On the other hand, in a case where the variable m>0 is not satisfied (step S2006: No), the specifying device 100 proceeds to the processing of step S2007.

In step S2007, the specifying device 100 sets the variable m=0 (step S2007). Then, the specifying device 100 proceeds to the processing of step S2008.

In step S2008, the specifying device 100 calculates the variable y=√{(b\hat{ }2)×(1−m\hat{ }2)} (step S2008). Then, the specifying device 100 calculates the variable s=1/(1+y) (step S2009). Next, the specifying device 100 adopts the variable s as the similarity score, and adds the pair of the selected sentence ID and the similarity score to the array Work[ ] (step S2010). Then, the specifying device 100 proceeds to the processing of step S2011.

In step S2011, the specifying device 100 determines whether all the sentence IDs have been selected from the LSI score list 500 (step S2011). Here, in a case where there is an unselected sentence ID (step S2011: No), the specifying device 100 returns to the processing of step S2001. On the other hand, in a case where all the sentence IDs have been selected (step S2011: Yes), the specifying device 100 terminates the calculation processing. As a result, the specifying device 100 can accurately calculate the semantic similarity of each sentence with the input sentence.

Here, the specifying device 100 may change the order of processing of some steps in the flowcharts of FIGS. 19 and 20 and execute the processing. For example, the order of the processing in steps S1902 and S1903 and the processing in step S1904 can be exchanged. Furthermore, for example, the processing of step S1904 can be moved after the processing of step S1905 and before the processing of step S1906.

Furthermore, the specifying device 100 may omit the processing of some steps of the flowcharts illustrated in FIGS. 19 and 20. For example, the processing of steps S1905, and S1907 to S1909 can be omitted. Furthermore, for example, the processing of steps S2004 and S2005 can be omitted. Furthermore, for example, the processing of steps S2006 and S2007 can be omitted.

As described above, according to the specifying device 100, the first value indicating a result of the WMD between each sentence and the input first sentence for each sentence of the plurality of sentences stored in the storage unit 900 can be acquired. According to the specifying device 100, the second value indicating a result of the LSI between each sentence and the first sentence for each sentence of the plurality of sentences stored in the storage unit 900 can be acquired. According to the specifying device 100, the similarity between each sentence of the plurality of sentences and the first sentence can be calculated on the basis of the vector having the magnitude based on the first value acquired for the sentence and the orientation based on the second value acquired for the sentence, the vector corresponding to the sentence. According to the specifying device 100, the second sentence similar to the first sentence among the plurality of sentences can be specified on the basis of the calculated similarity between each sentence and the first sentence. Thereby, the specifying device 100 can calculate the similarity accurately indicating how much the input first sentence and each sentence of the plurality of sentences are semantically similar. Then, the specifying device 100 can accurately specify the sentence semantically similar to the input first sentence from among the plurality of sentences.

According to the specifying device 100, in the case where the second value acquired for any of the plurality of sentences is less than a threshold value, the similarity between each sentence and the first sentence can be calculated on the basis of the vector corresponding to the sentence. According to the specifying device 100, in the case where the second value acquired for any of the plurality of sentences is equal to or larger than the threshold value, the second sentence can be specified among the plurality of sentences on the basis of the second value acquired for each sentence. Thereby, in the case where the second value is relatively large, and it can be determined that the second sentence semantically similar to the first sentence can be accurately specified on the basis of the second value, the specifying device 100 can reduce the processing amount without calculating the similarity.

According to the specifying device 100, in the case where the second value acquired for any of the plurality of sentences is a negative value, the second value acquired for any of the sentences can be corrected to 0. Thereby, the specifying device 100 can easily calculate the similarity with high accuracy.

According to the specifying device 100, the vector corresponding to each sentence, and having the magnitude based on the first value acquired for the sentence and the angle based on the second value acquired for the sentence with reference to the first axis of the predetermined coordinate system, can be defined. According to the specifying device 100, the similarity between the sentence and the first sentence can be calculated on the basis of the coordinate value on the second axis of the coordinate system, the second axis being different from the first axis of the defined vector. Thereby, the specifying device 100 can easily calculate the similarity with high accuracy.

According to the specifying device 100, a plurality of sentences including the same word as the first sentence can be extracted from the storage unit 900. According to the specifying device 100, for each sentence of the plurality of extracted sentences, the first value indicating a result of the WMD between the sentence and the input first sentence can be acquired. According to the specifying device 100, for each sentence of the plurality of extracted sentences, the second value indicating a result of the LSI between the sentence and the first sentence can be acquired. Thereby, the specifying device 100 can reduce the number of sentences for which the similarity is calculated and reduce the processing amount.

According to the specifying device 100, the first sentence is used as a question sentence, a plurality of sentences is used as question sentences associated with answer sentences, and an answer sentence associated with the specified second sentence can be output. Thereby, the specifying device 100 can implement the service for providing an FAQ.

According to the specifying device 100, the second sentence having the largest calculated similarity can be specified among the plurality of sentences. Thereby, the specifying device 100 can specify the second sentence that is determined to be semantically most similar to the first sentence.

According to the specifying device 100, the second sentence having the calculated similarity that is equal to or larger than a predetermined value can be specified among the plurality of sentences. Thereby, the specifying device 100 can specify the second sentence that is determined to be semantically similar to the first sentence by a certain level or more.

According to the specifying device 100, the first sentence can be a sentence written in Japanese, and the plurality of sentences can be sentences written in Japanese. Thereby, the specifying device 100 can be applied to the Japanese environment.

According to the specifying device 100, the specified second sentence can be output. Thereby, the specifying device 100 can enable the user of the FAQ system 200 to recognize the specified second sentence, and can improve the convenience of the FAQ system 200.

According to the specifying device 100, the result of sorting a plurality of sentences can be output on the basis of the similarity between each calculated sentence and the first sentence. Thereby, the specifying device 100 can enable the user of the FAQ system 200 to recognize which sentence of the plurality of sentences has a large semantic similarity to the first sentence, and can improve the convenience of the FAQ system 200.

According to the specifying device 100, the second value indicating a result of the LSI between each sentence and the first sentence for each sentence of remaining sentences stored in the storage unit 900 other than the plurality of extracted sentences can be acquired. According to the specifying device 100, the second sentence similar to the first sentence can be specified from the storage unit 900 on the basis of the calculated similarity between each sentence of the plurality of sentences and the first sentence, and the second value acquired for each sentence of the remaining sentences. Thereby, the specifying device 100 can specify the second sentence similar to the first sentence even from the remaining sentences other than the plurality of extracted sentences in the case of reducing the processing amount.

Note that the specifying method described in the present embodiment may be implemented by executing a program prepared in advance on a computer such as a personal computer or a workstation. The specifying program described in the present embodiment is recorded on a computer-readable recording medium such as a hard disk, flexible disk, compact disk read only memory (CD-ROM), magneto-optical disk (MO), or digital versatile disc (DVD), and is read from the recording medium and executed by the computer. Furthermore, the specifying program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a specifying program for causing a computer to execute processing, the processing comprising:
acquiring a first value that indicates a result of inter-document distance analysis between each of a plurality of sentences stored in a storage unit and an input first sentence;
acquiring a second value that indicates a result of latent semantic analysis between each of the sentences and the first sentence;
calculating similarity between each of the sentences and the first sentence on the basis of a vector that corresponds to each of the sentences and has magnitude based on the first value acquired for each of the sentences and an orientation based on the second value acquired for each of the sentences; and
specifying a second sentence similar to the first sentence among the plurality of sentences on the basis of the calculated similarity between each of the sentences and the first sentence.

2. The non-transitory computer-readable recording medium according to claim 1, wherein
the calculating of the similarity includes,
in a case where the second value acquired for any sentence of the plurality of sentences is less than a threshold value, calculating the similarity between each of the sentences and the first sentence on the basis of the vector that corresponds to each of the sentences, and
the specifying of the second sentence includes,
in a case where the second value acquired for any sentence of the plurality of sentences is equal to or larger than the threshold value, specifying the second sentence among the plurality of sentences on the basis of the second value acquired for each of the sentences.

3. The non-transitory computer-readable recording medium according to claim 1, wherein the processing further comprising:
in a case where the second value acquired for any sentence of the plurality of sentences is a negative value, correcting the second value acquired for the sentence to 0.

4. The non-transitory computer-readable recording medium according to claim 1, wherein
the calculating of the similarity includes
calculating the similarity between each of the sentences and the first sentence on the basis of a coordinate value on a second axis of a predetermined coordinate system, which is different from a first axis, of a vector that corresponds to each of the sentences and has the magnitude based on the first value acquired for each of the sentences and an angle based on the second value acquired for each of the sentences with reference to the first axis of the predetermined coordinate system.

5. The non-transitory computer-readable recording medium according to claim 1, the processing further comprising:
extracting a plurality of sentences that includes a same word as the first sentence from the storage unit, wherein
the acquiring of the first value includes
acquiring the first value that indicates a result of inter-document distance analysis between each of the plurality of extracted sentences and the input first sentence, and
the acquiring of the second value includes
acquiring the second value that indicates a result of latent semantic analysis between each of the plurality of extracted sentences and the first sentence.

6. The non-transitory computer-readable recording medium according to claim 1, wherein
the first sentence is a question sentence,
the plurality of sentences is question sentences associated with answer sentences, and
the processing further includes: outputting an answer sentence associated with the specified second sentence.

7. The non-transitory computer-readable recording medium according to claim 1, wherein
the specifying of the second sentence includes
specifying the second sentence that has the largest calculated similarity among the plurality of sentences.

8. The non-transitory computer-readable recording medium according to claim 1, wherein
the specifying of the second sentence includes
specifying the second sentence that has the calculated similarity that is equal to or larger than a predetermined value among the plurality of sentences.

9. The non-transitory computer-readable recording medium according to claim 1, wherein
the first sentence is a sentence written in Japanese, and
the plurality of sentences is sentences written in Japanese.

10. The non-transitory computer-readable recording medium according to claim 1, the processing further comprising:
outputting the specified second sentence.

11. The non-transitory computer-readable recording medium according to claim 1, the processing further comprising:
outputting a result of sorting the plurality of sentences on the basis of the calculated similarity between each of the sentences and the first sentence.

12. The non-transitory computer-readable recording medium according to claim 5, wherein
the acquiring of the second value includes
acquiring the second value that indicates a result of latent semantic analysis between each sentence of remaining sentences stored in the storage unit other than the plurality of extracted sentences, and the first sentence, and
specifying the second sentence similar to the first sentence from the storage unit on the basis of the calculated similarity between each of the plurality of sentences and the first sentence, and the second value acquired for each of the sentences of the remaining sentences.

13. A computer-implemented method comprising:
acquiring a first value that indicates a result of inter-document distance analysis between each of a plurality of sentences stored in a storage unit and an input first sentence;
acquiring a second value that indicates a result of latent semantic analysis between each of the sentences and the first sentence;
calculating similarity between each of the sentences and the first sentence on the basis of a vector that corresponds to each of the sentences and has magnitude based on the first value acquired for each of the sentences and an orientation based on the second value acquired for each of the sentences; and
specifying a second sentence similar to the first sentence among the plurality of sentences on the basis of the calculated similarity between each of the sentences and the first sentence.

14. A specifying device comprising
a memory; and
a processor coupled to the memory, the processor being configured to perform processing, the processing including:
acquiring a first value that indicates a result of inter-document distance analysis between each of a plurality of sentences stored in a storage unit and an input first sentence;
acquiring a second value that indicates a result of latent semantic analysis between each of the sentences and the first sentence;
calculating similarity between each of the sentences and the first sentence on the basis of a vector that corresponds to each of the sentences and has magnitude based on the first value acquired for each of the sentences and an orientation based on the second value acquired for each of the sentences; and
specifying a second sentence similar to the first sentence among the plurality of sentences on the basis of the calculated similarity between each of the sentences and the first sentence.
